(19) United States
(12) Patent Application Publication
(10) Pub. No.: US 2004/0100376 A1
(43) Pub. Date: May 27, 2004

(54) Healthcare monitoring system

(75) Inventors: Jason Lye, Atlanta, GA (US); Rosann Kaylor, Cumming, GA (US); Jeff Lindsay, Appleton, WI (US); Dennis Everhart, Alpharetta, GA (US)

Correspondence Address: STEPHEN E. BONDURA, ESQ., DORITY & MANNING, P.A., P.O. BOX 1449, GREENVILLE, SC, 29602-1449, US

(73) Assignee: KIMBERLY-CLARK WORLDWIDE, INC.

(21) Appl. No.: 10/305,263

(22) Filed: Nov. 26, 2002

(51) Int. Cl. G08B 1/08

(52) U.S. Cl. 340/539.12; 340/573.1; 600/300

(57) ABSTRACT

A wireless healthcare monitoring system and method are provided. At least one UWB biosensor transmitter is assigned to at least one individual to be remotely monitored. The biosensor transmitter includes a biosensor disposed to detect a health condition of a user and generate a corresponding biosensor reading. The reading is converted by the biosensor transmitter to an ultra wideband (UWB) biosensor signal transmitted by the biosensor transmitter. A UWB receiver disposed remote from and within range of the transmitter receives and converts the UWB biosensor signal to a signal containing information from the biosensor reading. A processor in communication with the UWB receiver processes and displays the converted signal as a readable output indicating a health condition of the user detected by the biosensor.

### FIELD OF THE INVENTION

The present invention relates generally to the field of healthcare monitoring systems, and more particularly to a wireless monitoring system.

### BACKGROUND

There are many scenarios in the healthcare field wherein a patient or group of patients require remote monitoring for any one of a number of particular health conditions. For example, premature infants in a hospital's neonatal care unit require virtually constant monitoring of vital statistics, bodily functions, and the like. In many instances, it may be required to monitor for a particular condition or suspected condition, such as low blood sugar, infection, and so forth, wherein it may be necessary to draw a blood or other biological sample from the infant. Such monitoring and testing is labor intensive, requires highly trained personnel, and can become a significant draw on the medical staff, particularly as more patients are added to the monitored group. A similar situation may exist in healthcare facilities for the care of elderly and infirmed persons. A large number of patients at a facility may require simultaneous monitoring for any number of healthcare reasons.

Bedside monitoring devices are widely know and used in such situations for monitoring an individual patient's statistics and functions, for example, temperature, blood pressure, blood oxygen level, and so forth. These devices incorporate sensors that are hard-wired to a portable receiver/display unit. This unit typically provides a visible read-out or display of the measured parameter, as well as an alarm in the event that an abnormal reading is obtained. The bedside units are typically hardwired to a remote monitoring station as well, particularly the alarm functions. This arrangement, however, has many drawbacks. The electronic hardware is expensive and the hardwire configurations take up vital space. The mass of wire connections can become quite complicated and confusing. Precautions must be taken that the patient cannot inadvertently (or purposefully) disconnect the wire connections. The various wire connections may make it difficult for the medical staff to administer certain procedures. In the case of elderly or infirmed persons, the wire connections severely limit the person's mobility.

Much work has been done in the healthcare industry related to the use of diagnostic biosensors, particularly for the use of such devices in hospitals and managed care facilities. Recently, many technologies have been proposed for biosensors that can be used at home, including disposable or single-use devices. Further, technologies have been proposed that could be incorporated into an item that is worn on or near the body, such as in a disposable diaper, incontinence device, sanitary napkin, an article of clothing, and the like. Finally, it has also been proposed to use portable or disposable biosensors equipped with electronic devices that can store or transmit data relevant to the health of a subject.

Relatively small and unobtrusive biosensors for individual diagnostic and monitoring use offer many opportunities for improved health care, particularly in the scenarios wherein a relatively large number of patients must be simultaneously monitored for any one or combination of health conditions. The present invention relates to an improved remote monitoring system utilizing such biosensors and a unique wireless transmission configuration that addresses at least certain drawbacks of conventional systems and offer the healthcare provider significant options, mobility, and freedom in the monitoring of patients.

### SUMMARY OF THE INVENTION

Objects and advantages of the invention will be set forth in part in the following description, or may be obvious from the description, or may be learned through practice of the invention.

The present invention provides an improved healthcare monitoring system and method that incorporates the benefits of individual diagnostic biosensors and a digital pulse wireless transmission configuration. The biosensors are incorporated into a self-contained and individually powered digital pulse wireless transmitter. The transmitter incorporates “ultra-wideband” (“UWB”) technology, which is a fairly recent development in the radio communication field. The UWB technology permits the use of a large number of biosensor transmitters in relatively close proximity with virtually no interference with each other or other conventional RF communication systems. The biosensor transmitters require very low power and, thus, can monitor and transmit continuously if necessary with the use of a self-contained battery or other type of power supply.

A UWB receiver receives and decodes the transmitted pulse trains into a signal containing the information from the initial biosensor reading. The receiver may be placed relatively close to the biosensor transmitters, for example in the same room or ward, or may be placed in a remote location. The UWB technology is particularly well suited for wireless “through-wall” communication. The received signal is interpreted by a suitable processor associated with the receiver and a visual and/or audio readout is provided to the healthcare attendant at a remote location.

As discussed in greater detail below, a vast number and type of biosensors may be utilized with the present invention for monitoring and diagnosis of a wide variety of healthcare conditions. For example, biosensors that detect an analyte of interest in a biological sample or medium are well know, the presence or absence of the analyte being indicative of a particular health condition. For use with the present invention, the detectable or measurable biosensor parameter (e.g., resistance, capacitance, light, etc.) corresponds to a biosensor reading that is converted into a timed pulsed UWB biosensor signal that is then transmitted in a precisely timed pulse sequence over a wide RF transmission bandwidth. The biosensor transmitters can transmit over a RF spectrum occupied by existing radio and other RF communication devices without causing interference. This feature may be particularly important from an accuracy and reliability standpoint in healthcare facilities wherein various RF systems are utilized for any number of reasons. It is important that the monitoring system not be degraded by other RF transmission systems, or cause degradation of such other RF systems.

Although the monitoring system of the present invention is particularly beneficial for simultaneously monitoring a plurality of subjects at one or more locations, the system is not limited to this environment. For example, the system may be beneficial for individuals who do not need to be in a hospital or clinical facility, but do require some degree of monitoring for particular health concerns. Such an individual may carry or wear the biosensor at home or other location so long as they are within range of the UWB receiver. The receiver may be placed, for example, in the user's home at a generally central location. The receiver may, in turn, be in communication with a healthcare facility, emergency response facility, etc., for transmission of the biosensor signal by conventional means. This situation may apply particularly to certain elderly or homebound persons.

It is also within the scope and spirit of the invention to establish monitoring schemes at, for example, schools, day care facilities, prison facilities, and the like, wherein it may be necessary to remotely monitor one or a plurality of persons for various healthcare concerns without unnecessarily restricting the person's mobility.

Turning now to the generation of the biosensor signal(s), one or more biosensors may measure one or more analytes related to the health of a subject (in many cases, a patient). The biological sample or medium that may contain the targeted analyte can be withdrawn or collected from the subject's body, such as an analyte in a body fluid or biological sample. An analyte from the subject's body can be obtained by collection of a body fluid or biological sample that is invasively withdrawn (e.g., blood or spinal fluid) or collected after passing outside the body of the subject. The analyte need not be removed from the body of the subject, as in cases where a measurement is made on or through the skin or other tissues of the body, such as optical measurement of a substance in the blood. In one embodiment, the analyte can be noninvasively withdrawn through unbroken skin or mucosal membranes by noninvasive electro-osmotic withdrawal, as disclosed in U.S. Pat. No. 6,059,736, “Sensor Controlled Analysis and Therapeutic Delivery System,” issued May 9, 2000 to R. Tapper, incorporated herein by reference.

A biosensor can be in contact with the body or in fluid communication with the body. It can be placed on or adjacent to the skin or other member of the body (generally in fluid communication therewith), in an orifice of the body, inside the body (e.g., a surgically implanted device or a device that is swallowed or introduced by a catheter), in an article that is worn next to the body, and so forth. Biosensors or components thereof can be attached to the skin with hydrogels, including poly(2-hydroxyethyl methacrylate) (PHEMA), whose methods of preparation are described, for example, in A. C. Duncan et al., “Preparation and characterization of a poly(2-hydroxyethyl methacrylate),” European Polymer Journal, Vol. 37, No. 9, September 2001 (published Jul. 6, 2001), pp. 1821-1826.

Biosensors can be spaced apart from the body, such as a biosensor measuring compounds in human breath (e.g., an electronic nose) or other body odors, where they can be in vapor communication with the body. Biosensors spaced apart from the body also include those measuring material removed from the body for separate analysis, such as a blood sensor measuring analytes in withdrawn human blood. Such biosensors can be at any distance from the body, while odor sensors and the like generally should be within a predetermined distance from the body of the subject such as within 15 inches of the body or within 6 inches or 3 inches of the body (i.e., within 6 inches or 3 inches of the closest source of the analyte being measured). In one embodiment, the biosensor (particularly the sensing element thereof) is at least 1 inch away from the body, more specifically at least 3 inches away from the body.

Biosensors can be placed in disposable absorbent articles such as diapers, disposable training pants such as HUGGIES® Pull-Ups®, bed pads, sanitary napkins, panty liners, tampons, interlabial devices, colostomy bags, breast pads, incontinence devices such as incontinence pads, briefs or undergarments. They can also be placed in other devices for collection or disposal of body fluids and other biological waste matter, as exemplified by the flexible waste bags described in WO 00/65348, which can be flexible receptacles for the containment of excreted fecal matter or urine, and in waste receptacles for diapers or other disposable materials, bedpans, toilet bowls, vomit bags, and the like. Biosensors can be associated with an article of clothing such as a shirt, underwear, a vest, a protective suit, an apron or bib, a hat, socks, gloves, or a disposable gown (particularly for medical or surgical use, or for use by a patient), or can be associated with any other object that can be in contact with or near the body, such as a pillow, bed linens, a mattress, breathing tubes, a helmet, face masks, goggles, article of jewelry such as a bracelet or necklace, an ankle bracelet such as those used for prisoners or those on probation, and the like. They can also be physically associated with a wide variety of other objects, such as suppositories, tongue depressors, cotton swabs, cloth towels or paper towels, spill cleanup bags, desiccant bags, disposable mops, bandages, wipes, therapeutic wraps, supports, disposable heating pads, articles of furniture, food containers, and the like.

In specifying where a biosensor is placed, it is understood that not all of the components of the biosensor transmitter must be so placed together on, for example, a common carrier or substrate. The biosensor element may be disposed remote from the remaining components of the transmitter. For example, the biosensor element may be implanted in a patient and attached (wired) to transmitter components carried on the outside of the patient's body. In another embodiment, the biosensor element may be placed in a diaper, while other components of the biosensor transmitter, such as a power supply or signal generator, may be located remote from the biosensor element.

Biosensor signals may be continuous or discrete, and may be taken over a short period of time, such as a single measurement from one biological sample, multiple measurements over a period of hours or days, averaged measurements, continuous measurement during a prolonged period of time, and the like.

Aspects of the invention will be described in greater detail below.

### BRIEF DESCRIPTION OF THE DRAWINGS

The present invention will be more fully understood and further advantages will become apparent when reference is made to the following detailed description of the invention and the accompanying drawings. The drawings are merely representative and are not intended to limit the scope of the claims.

FIG. 1 is a diagrammatic representation of a monitoring system and associated method in accordance with the invention.

FIG. 2 is a diagrammatic representation of an alternate monitoring system and method according to the invention.

FIG. 3 is a block diagram representation of a type of UWB biosensor transmitter that may be used with the invention.

FIG. 4 is a block diagram representation of a type of UWB receiver that may be used with the invention.

FIG. 5 is a block diagram of an alternate embodiment according to the invention.

### DETAILED DESCRIPTION OF THE PREFERRED EMBODIMENTS

Reference will now be made in detail to particular embodiments of the invention, one or more examples of which are illustrated in the figures. Each described embodiment and example is provided by way of explanation of the invention, and not meant as a limitation of the invention. For example, features illustrated or described as part of one embodiment may be used with another embodiment to yield still a further embodiment. It is intended that the present invention include these and other modifications and variations.

As used herein, the term “analyte” means an atom, ion, molecule, macromolecule, organelle, or cell that is detected and measured. The term “analyte” also means a substance in a medium including, but not limited to molecules such as proteins, glycoproteins, antibodies, antigens, hemoglobin, enzymes, target molecules that bind to or react with specific enzymes or other proteins, metal salts, ions (e.g., hydrogen ions, hydroxy ions, sulfates, sulfonates, phosphates, nitrates, nitrites, or electrolytes such as sodium potassium, lithium, or calcium ions), fatty acids, neurotransmitters, hormones, growth factors, cytokines, monokines, lymphokines, lipocalins, nutrients, sugars, receptors, nucleic acids, fragments of DNA or RNA, and pharmaceutical agents or derivatives or metabolites thereof. The term “analyte” also means structured elements such as macromolecular structures, organelles and cells, including, but not limited to cells of ectodermal, mesodermal, and endodermal origin such as stem cells, blood cells, neural cells immune cells, and gastrointestinal cells, and also microorganisms, such as fungi, viruses, bacteria and protozoa, or characteristic compounds produced by the same. For example, in pH measurement, the analyte can be hydrogen ions and/or hydroxy ions. Some analytes indicate a possible disease condition by either a higher or lower than normal level.

As used herein, “biosensor,” following the definitions given in the CancerWeb Online Medical Dictionary at www.graylab.ac.uk/cgi-bin/omd?biosensor, refers to any sensor that collects data about a biological or physiological process. Biosensors can include any probe, such as those including biological material, which measures the presence or concentration of analytes such as biological molecules, biological structures, microorganisms, etc., by translating a biochemical interaction with the probe into a physical signal. More specifically, the term can refer to the coupling of a biological material (for example, enzyme, receptor, antibody, whole cell, organelle) with a microelectronic system or device to enable rapid low level detection of various substances in body fluids, water, and air.

As used herein, a “biosensor reading” refers to a quantitative or qualitative measurement provided by a biosensor, which, without limitation, can be in the form of an electronic signal, either a digital or analog signal (such as electrical current or a voltage generated directly by the biosensor or indirectly by another device in response to a biosensor reading) that can in turn be transmitted and result in a display on an output device or in data being transmitted to a computer.

As used herein, “medium” and “biological sample” can refer to any material that can contain an analyte to be measured. A medium or biological sample can be any body fluid, including blood or any of its components (plasma, serum, etc.), menses, mucous, sweat, tears, urine, feces, saliva, sputum, semen, uro-genital secretions, gastric washes, pericardial or peritoneal fluids or washes, a throat swab, pleural washes, ear wax, hair, skin cells, nails, mucous membranes, amniotic fluid, vaginal secretions or any other secretions from the body, spinal fluid, human breath, gas samples containing body odors, flatulence or other gases, any biological tissue or matter, or an extractive or suspension of any of these.

As used herein, the terms “ultra wideband” (UWB) and “digital pulse wireless” refer to Radio Frequency (RF) devices that operate by employing very narrow or short duration pulses resulting in very large or “wideband” transmission bandwidths. As defined by the Federal Communications Commission (FCC), the bandwith of UWB systems is more than 25% of a center frequency or more than 1.5 GHz. UWB is typically implemented in a carrierless fashion. As compared to conventional “narrowband” and “wideband” systems using RF carriers to move the signal in the frequency domain from baseband to the actual carrier frequency where the system is allowed to operate, UWB implementations directly modulate an “impulse” that has a sharp precise rise and fall time, thus resulting in a waveform that occupies several GHz of bandwidth.

Aspects of UWB technology are discussed below for a general appreciation of certain capabilities of the monitoring system according to the present invention. For a detailed description of UWB technology, reference is made to “Ultra-Wideband Technology for Short- or Medium-Range Wireless Communications,” published in Intel Technology Journal, 2^{nd} Quarter, 2001. Reference is also made to the following U.S. Patents for a detailed description of UWB technology and various implementations thereof: U.S. Pat. No. 6,300,903 B1; U.S. Pat. No. 6,218,979 B1; U.S. Pat. No. 6,177,903 B1; U.S. Pat. No. 5,832,035; U.S. Pat. No. 5,687,169; U.S. Pat. No. 5,677,927; and U.S. Pat. No. 5,361,070. These patents are incorporated herein by reference in their entirety for all purposes.

UWB is a wireless technology for transmitting large amounts of digital data over a wide spectrum of frequency bands with very low power. UWB radio has the ability to carry signals through doors, walls, and other obstacles that tend to reflect signals at more limited bandwidths and higher power. UWB broadcasts a larger number of digital pulses that are less than one nanosecond in duration and timed very precisely across a wide frequency spectrum at the same time. The transmitter and receiver must be coordinated to send and receive pulses with an accuracy of trillionths of a second. On any given frequency band that may already be in use, the UWB has so low power and is so broadly spread that it appears as mere background noise. Thus, theoretically, the UWB signal is not subject to interference, and does not subject other devices to interference. A UWB system's power consumption requirements are around one ten-thousandth of that of conventional cell phones.

UWB systems generally possess the following characteristics: short duration pulses; center frequencies typically between 50 MHz and 10 GHz; ultrawide bandwidths of 100+% of the center frequency; multi-mile ranges with sub-milliwatt average power levels (even with low gain antennas); extremely low power spectral densities; lower cost than other sophisticated radio designs; and excellent immunity to fading and jamming from other systems. Very high processing gains are possible with UWB systems. For example, a receiver in a 10 megapulse/sec (100 ns frame) system with a 1 ns pulse need only “listen” when the 1 ns pulse is expected to arrive, obtaining 20 dB of noise rejection. If 100 pulses are set per data bit, an additional 20 dB of gain is achieved in an overall 100 kilobit/sec link. Processing gains of 40 dB or better can be obtained, allowing robust data transmission at levels comparable to or less than ambient noise. The short duration pulses have excellent multipath immunity and do not suffer the pronounced fades of conventional narrowband systems.

The FCC has approved UWB for limited commercial implementation, including medical imaging systems that may be used for a variety of health applications to “see” inside the body of a person or animal. Implementation has also been approved for communication and Measurement systems, such as home and business networking devices. The medical devices and communication systems are limited to the frequency band of 3.1 to 10.6 GHz.

UWB technology has also been implemented in a microchip and is thus particularly well suited for incorporation with a biosensor. For example, Time Domain of Huntsville, Ala., USA, provides UWB technology as a single integrated circuit chipset under the name of PulsOn®. It is believed that the PulsOn® chipsets may be readily incorporated with a wide variety of conventional biosensor technologies to provide a UWB biosensor transmitter. PulseLINK of San Diego, Calif., USA, is also another commercial source of UWB technology.

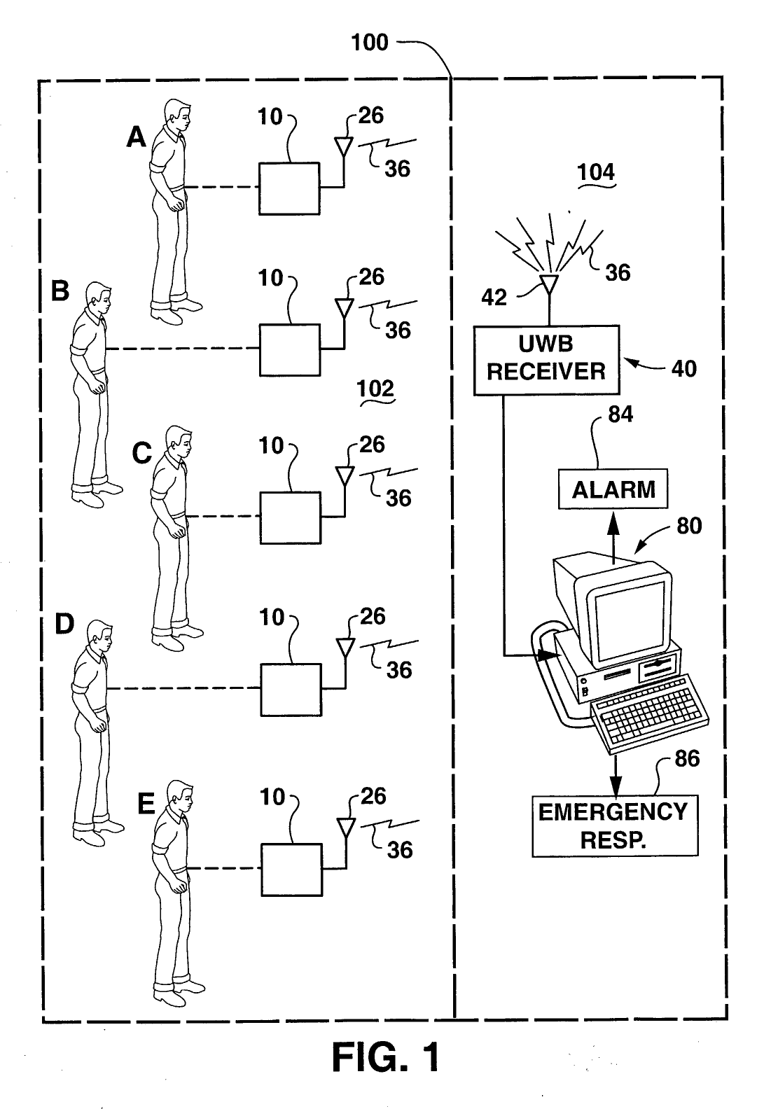

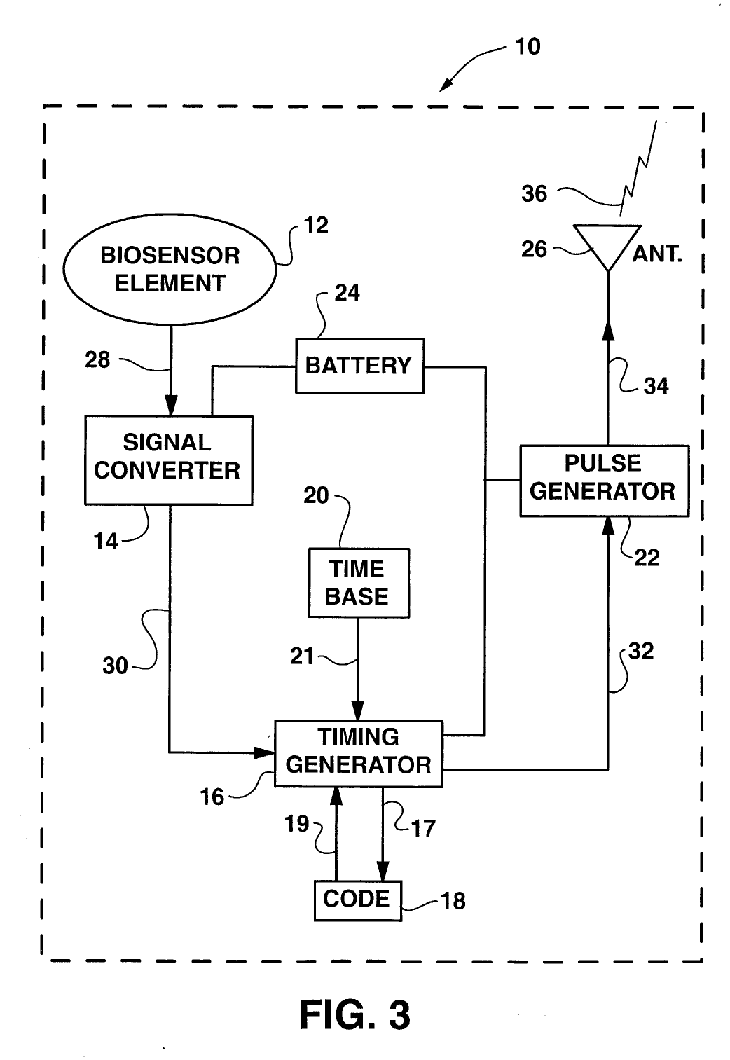

Exemplary embodiments of a monitoring system and method according to the invention are illustrated schematically in the figures. Referring to FIG. 1, a monitoring system according to the invention includes at least one UWB biosensor transmitter 10 associated with at least one individual “A”. A plurality of individuals (A through E) may be monitored with the system wherein each individual A through E is assigned at least one biosensor transmitter 10. The biosensor transmitters 10 will be described in greater detail below. Each biosensor transmitter 10 includes at least one biosensor element 12 (FIG. 3) that is disposed relative to the individual A to detect a health condition of the individual. For example, the biosensor element 12 may detect an analyte of interest in a biological sample or medium from the individual A, the analyte being indicative of a particular health condition. It should be appreciated that the individuals A through E may be monitored for the same health condition or different health conditions. It should also be appreciated that the individuals A through E may have any number of associated biosensor transmitters 10 assigned thereto. Each such biosensor transmitter 10 may monitor for a different health condition.

A reading from the biosensor elements 12 are converted by the biosensor transmitter 10 to a biosensor signal 36 transmitted by way of an antenna 26. The biosensor signal 36 is a UWB signal, as described above.

A UWB receiver 40 is disposed remote from and within range of the biosensor transmitters 10. For example, the monitoring system may be utilized in any structure 100 (dashed lines in FIG. 1), such as a hospital, nursery, elderly care facility, school, and the like. The biosensor transmitters 10 and monitored individuals A through E may be located within a particular room 102 of a structure 100, and the UWB receiver 40 may be located in a different room 104, or the same room 102. For example, in the embodiment wherein the structure 100 is a ward or floor of a hospital, the room 102 may correspond to an infant nursery, for example a neonatal care nursery. The room 104 may correspond to an adjacent monitoring room or space, for example a nurses station, or the like. The system and method according to the invention are not limited in any way by area, location, or type of individuals monitored.

The UWB receiver 40 receives the transmitted biosensor signals 36 by way of an antenna 42. As described in greater detail below, the signals 36 are converted from UWB signals to a base signal 76 containing information from the original biosensor reading. The base signal 76 is then transmitted to a suitable processor 80 that processes and displays the signal as a readable output to a healthcare attendant. The output may be displayed visually, audibly, or a combination of both. The processor 80 may include any combination of suitable hardware and software architecture configured for displaying the information contained in the original biosensor reading. Thus, it should be appreciated, that the processor 80 will be configured for the individual types of biosensor elements 12 utilized by the biosensor transmitters 10.

Upon receipt of the base signal 76, the processor may add a time stamp and other identifying information for storage in a database, or time and other information may be added by the UWB receiver or may be transmitted by the biosensor transmitter 10 with the biosensor signal 36.

It is within the scope and spirit of the invention that the processor 80 conduct other various functions. For example, the processor 80 may include any one of a wide variety of electronic dataloggers for receiving and storing the biosensor signals 36 or base signals 76 over a period of time and then optionally computing and displaying results from the accumulated signals, or transferring the data to another device for optional computation and display of an interpretation of the data for review by other parties. Exemplary dataloggers include the cable and wireless dataloggers of Ellab-A/S of Denmark (with offices in San Hosea, Calif.), and other suitable dataloggers.

The processor 80 may display the results of the biosensor readings in any suitable format. For example, the results can include qualitative or quantitative results displayed on a screen or other display device in the form of text, bar graphs, a numerical value, charts, icons, color, and so forth, or can be a sound such as a synthetic voice, a beeping of variable frequency or tensity, a vibration of a physical device, and the like. Detailed display of information with interpretive guidance on a computer screen or the like with live hypertext for additional information represents one embodiment for the display and output of the biosensor readings.

Numerous “downstream” options are also available. For example, the biosensor signals 36, base signal 76, or interpretative results can be transmitted to a remote location by the processor 80 through any conventional means for review by other healthcare professionals, and the like. For example, the processor 80 may communicate the signals or interpretative results by way of phone line, RF circuitry, cable, secure Internet connections, and the like. The information may then be stored in an appropriate database, or supplied to a healthcare network for any number of reasons. The downstream transmissions, storage, etc., may be accomplished by any conventional hardware and software architecture. It should be appreciated that uses of the electronic biosensor signals within a healthcare facility or network are virtually limitless.

Means may also be provided to generate an alert signal or alarm to a healthcare attendant in the event that an abnormal biosensor reading is obtained. For example, the processor 80 may actuate an audible or visible alarm 84 in the event that the results of the biosensor readings are abnormal. The processor 80 may also automatically transmit a signal to an emergency response station 86, for example a facility, caregiver, specialist, or the like, in the event that the biosensor readings indicate a health condition requiring immediate medical attention. In this regard, the processor 80 may incorporate software and hardware means to distinguish an abnormal reading from a hardware problem, such as a disconnected electrode or improper use of the biosensor transmitters 10. Neural networks and fuzzy logic systems may be incorporated with the processor 80 to make these distinctions.

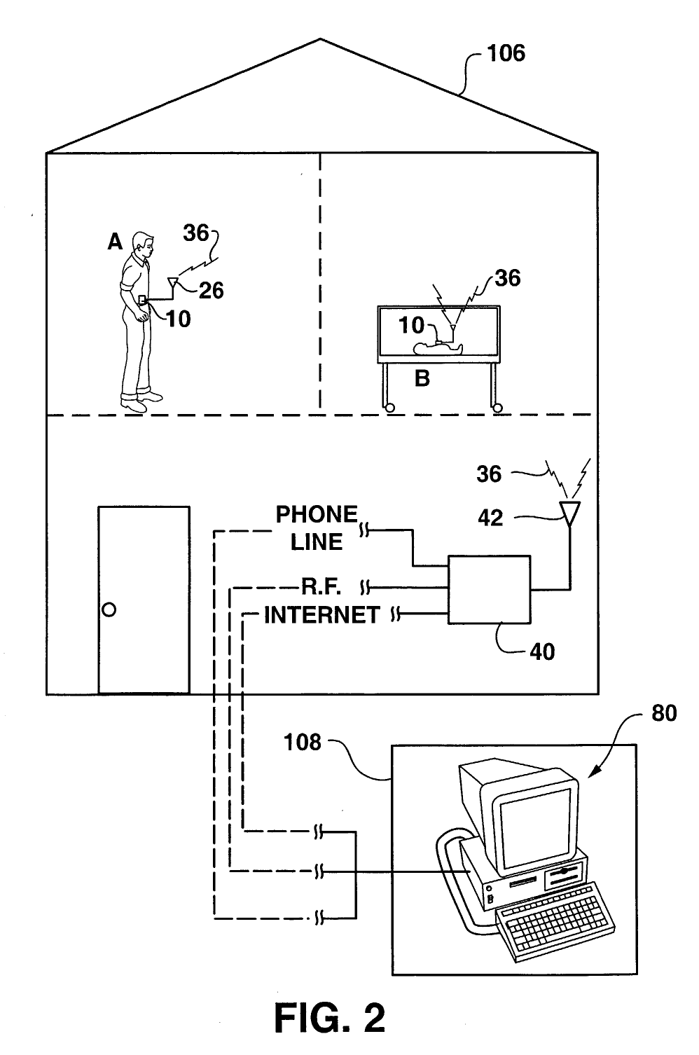

FIG. 2 diagrammatically represents an alternative embodiment of the method and system according to the invention for remotely monitoring any number of individuals for health conditions. In this representation, the monitored individual A has a biosensor transmitter 10 assigned thereto, for example carried against the individual's skin, disposed in an ostomy bag carried by the individual, disposed in an incontinence article, and the like. The individual A may be located in a remote structure 106, for example the individual's home. The individual B illustrated in FIG. 2 is an infant having a biosensor transmitted 10 associated therewith. For example, the transmitter 10 may be placed in a diaper or other absorbent article worn by the infant. A UWB receiver 40 may be disposed within the house or other structure 106 at a location such that the biosensor transmitters 10 are always within range of the receiver 40. The receiver 40 may, in turn, be in communication with a processor 80 in a remote building 108, such as a hospital, clinic, or other medical care facility. The devices may be in communication by any conventional means, including phone line, RF circuitry, internet connections, and the like.

It should be appreciated from the schematic representations of FIGS. 1 and 2 that a countless number of configurations of biosensor transmitters 10 and receivers 40 may be configured within the scope and spirit of the invention.

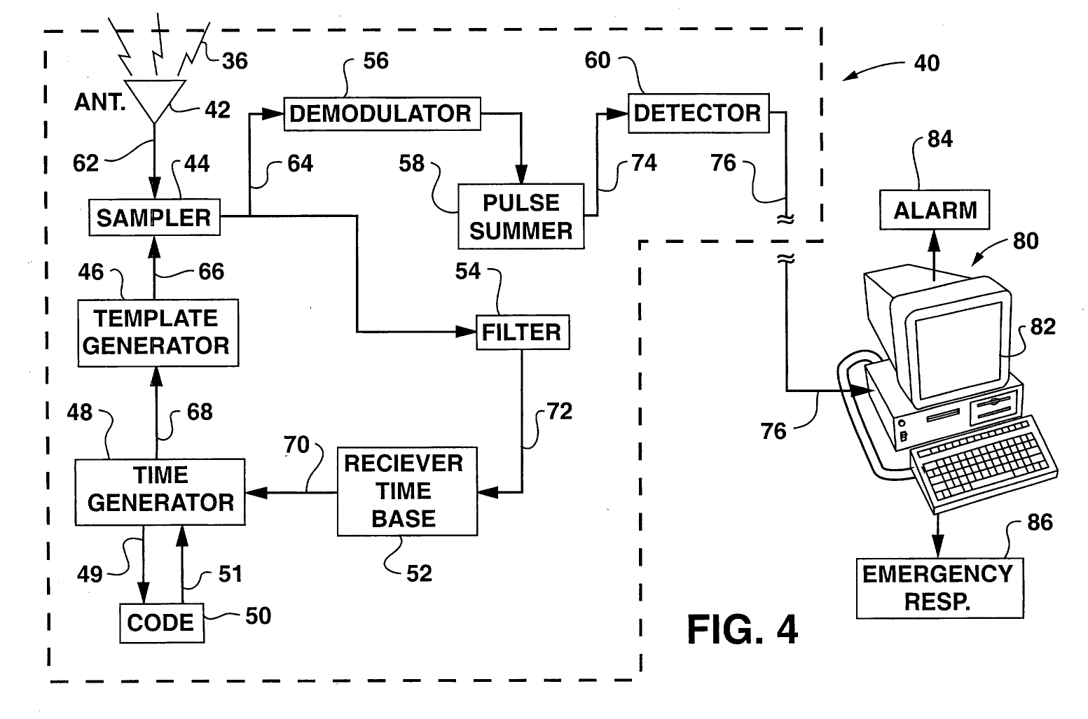

An exemplary embodiment of a biosensor transmitter 10 is illustrated in FIG. 3, and an exemplary embodiment of a UWB receiver 40 is illustrated in FIG. 4. The UBW system may use any type of modulation, including AM and time shift (pulse position) modulation. The time shift or pulse position modulation method may be particularly desirable due to its simplicity and relatively low power output characteristics. The time shift method is used as the illustrative example. The pulse-to-pulse interval in the UWB biosensor signal can be varied on a pulse-by-pulse basis by use of a psuedo-random code component. Psuedo-random codes (PN codes) are used to spread normally narrow band information signals over a relatively wide band of frequencies. A spread spectrum receiver correlates the signals to retrieve the original information signal. The PN codes may be thought of as a set of time positions defining the random positioning for each pulse in a sequence of pulses. The PN codes can be designed to have low cross correlation such that a pulse train using one code will seldom collide on more than one or two pulse positions with a pulse train using another code during any one data bit time. Digital time shift modulation can be implemented by shifting the coded time position by an additional amount (in addition to the PN code). This amount is typically very small relative to the PN code shift, and may be, for example in the pico-second (ps) range as compared to the nano-second (ns) rang of the PN codes.

In a typical UWB system utilizing time shift modulation, each data bit typically time position modulates many pulses of the periodic timing signal. This yields a modulated, coded timing signal that comprises a train of identically shaped pulses for each signal data bit. The receiver integrates multiple pulses to recover the transmitted information.

The UWB receiver 40 is typically a direct conversion receiver with a front end correlator that converts the electromagnetic pulse train to a base band signal in a single stage. This base band signal is the basic information signal for the UWB system. It may be desirable to include a subcarrier with the base band signal to help reduce the effects of amplifier drift and low frequency noise. The receiver 40 can receive UWB biosensor signals and demodulate the information using either the direct path signal or any multi-path signal peak having sufficient signal to noise ratio. Thus, the receiver can select the strongest response from among the many arriving signals.

The biosensor transmitter 10 incorporates any suitable self-contained power supply, such as a small battery 24, to supply necessary power to certain components of the transmitter. The battery 24 may be, for example, a watch battery, thin film battery, and the like. Thin profile batteries have been used in Smart Card applications, and such systems may be particularly well suited for the biosensor transmitters 10 of this invention. For example, an example of a card with a thin battery is disclosed in U.S. Pat. No. 6,284,406 entitled “IC Card with Thin Battery,” incorporated in its entirety herein for all purposes. Other suitable power supplies may include high efficiency solar cells, photovoltaic cells, and chemical reaction power cells. One type of power supply that may be particularly well suited for a biosensor transmit or is a “thermo generator” powered chip that converts an individual's body heat into enough electricity to power small electronic devices, such as a wrist watch. Such devices are being developed by, for example, Infineon Technologies of Munich, Germany.

Referring to the exemplary embodiment of the biosensor transmitter 10 illustrated in FIG. 3, a biosensor element 12 is provided. The biosensor element 12 may be any biosensor that detects a health condition of an individual. Suitable biosensor elements 12 are described in detail below. In summary, the biosensor element 12 generates a detectable or measurable biosensor reading 28. That reading 28 may be any one or combination of different types of information signal, including digital bits, analog signals, voltage signals, or the like. The biosensor elements 12 may employ electrical, optical, acoustical, chemical, electrochemical, or immunological technologies. Many biosensors include a sensing layer associated with a transducer. The sensing layer interacts with a medium including one or more target analytes. The sensing layer includes a material that binds to the analytes and can be, for example, an enzyme, an antibody, a receptor, a microorganism, a nucleic acid, and the like. Upon binding of the analyte with the sensing layer, a physiochemical signal induces a change in the transducer. The changer in the transducer permits a measurement or a reading that can be optical (e.g., a viewable diffraction pattern), potentiometric, gravimetric, amperometric, conductimetric, dielectrimetric, calorimetric, acoustic, and the like. A signal converter 14 may receive the biosensor reading 28 and converts the reading to a signal 30 accepted by a timing generator 16. In this embodiment, the signal 30 is a digital bit signal representing the information in the biosensor reading 28. In one example, the signal converter 14 may be an analog to digital converter, or the like. In an embodiment wherein the biosensor 12 emits a quantity of detectable light or fluorescents emission, the signal converter 14 may include, for example, an array of photodiodes to convert the light into electrical impulses. It should thus be appreciated that the “signal converter” 14 encompasses any configuration of hardware and/or software that converts the biosensor reading 28 to an appropriate signal 30 for subsequent processing. In the illustrated embodiment, the UWB system is a digital system and the signal 30 is thus a digital bit signal. However, the signal may be an analog signal or complex signal depending on the particular UWB architecture. The transmitter 10 may include a time base element 20 that generates a periodic timing signal 21 to a precision timing generator 16. The time base element 20 is typically a voltage controlled oscillator (VCO) having a high timing accuracy on the order of picoseconds (ps). The VCO center frequency is set at calibration to a desired center frequency used to define the transmitters nominal pulse repetition rate.

The precision timing generator 16 provides a synchronization signal 17 to a code source 18. The code source 18 outputs a code source signal 19 to the timing generator 16. The timing generator 16 uses the information signal 30 and code signal 19 to generate a modulated coded timing signal 32. The signal 32 may optionally be generated on a subcarrier signal. The code source 18 includes a storage device, such as random access memory (RAM) for storing suitable PN codes and for outputting the PN codes as the code signal 19.

The pulse generator 22 receives the modulated coded signal 32 and uses the signal as a trigger to generate output pulses 34. The output pulses 34 are sent to a transmitting antennae 26. The output pulses are converted into a propagating electromagnetic pulse signals 36 by the antennae 26. Thus, the initial biosensor reading 28 is eventually transmitted as a train of electromagnetic pulses 36 in a radio frequency environment.

Referring to the exemplary receiver architecture 40 depicted in FIG. 4, the output pulse signals 36 are received by an antennae 42. A received signal 62 is input to the front end correlator or “sampler” 44 coupled to the antennae 42. The correlator 44 produces a base band output signal 64. The receiver 40 also includes a precision timing generator 48 which receives a timing signal 70 from a time base element 52. The time base element is adjustable and is controlled in time, frequency, or phase as required by the lock loop filter 54 in order to lock onto the received signal 64. The timing generator 48 provides a synchronization signal 49 to the code source 50, and receives a code control signal 51 from the code source 50. The timing generator 48 utilizes the timing signal 70 and code control signal 51 to produce a coded timing signal 68. A template generator 46 is triggered by the coded timing signal 68 and produces a train of template signal pulses 66 having wave forms substantially equivalent to each pulse of the received signal 62. Thus, the code for receiving a given signal is the same code utilized by the originating transmitter to generate the propagated signal. The timing of the template pulse train matches the timing of the received signal pulse train, allowing the received signal 62 to be synchronously sampled by the correlator 44.

If the signal was carried on a subcarrier, the output of the correlator 44 is supplied to a demodulator 56 which demodulates the subcarrier information signal from the subcarrier signal. The output of the demodulator 56 is filtered or integrated in a pulse summation device 58. The output 74 of the summation stage 58 may be sampled by a sample and hold device and then compared with a reference signal output in a detector 60 to determine an output signal 76 representing the digital state of the output voltage of the sample and hold device.

A control loop comprising the filter 54, time base 52, timing generator 48, template generator 46, and correlator 44 is used to generate an error signal 72. The error signal 72 provides adjustments to the time base 52 to ensure that the periodic timing signal 66 is adjusted in relation to the position of the received signal 62.

A more detailed description of the UWB transmitter and receiver may be found in U.S. Pat. No. 6,300,903 B1 incorporated in its entirety herein by reference for all purposes.

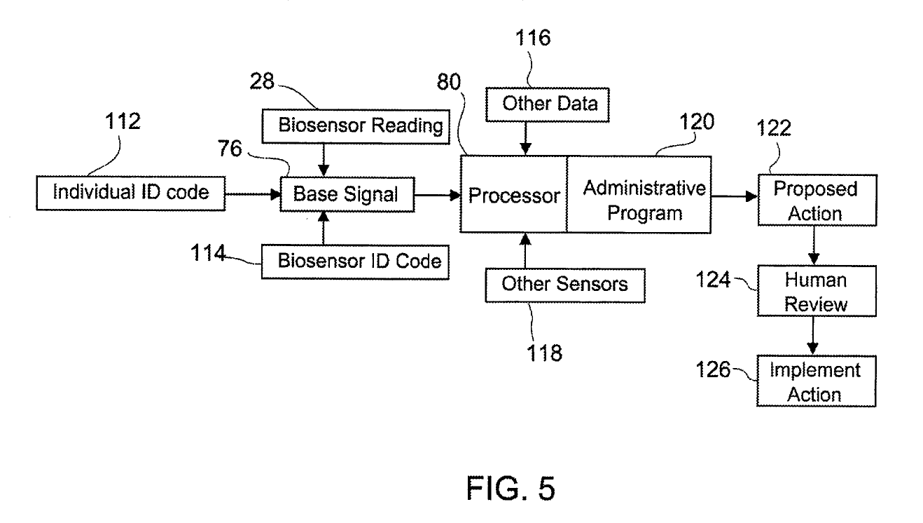

As shown in FIG. 5, the processor 80 can include or be associated with an administrative program 120 that can comprise an expert system or other program for evaluating the significance of the biosensor reading 28. Other sources of data can be provided to the processor 80 for consideration by the administrative program 120, including an individual ID code 112 (e.g., a code read by an RFID scanner from a smart tag associated with the individual) and a biosensor ID code 114 (e.g., a unique electronic identifier, including a smart tag code read by an RFID reader, that identifies the biosensor or each of a plurality of biosensors), both of which can be (but need not be) provided in the base signal 76 transmitted by UWB means to the processor 80. Data sources can be transmitted by other means to the processors, such as data from other sensors 98 that can be provided across wires or conventional radio signals, as well as other data 96 which can include medical records from a medical database, online databases of disease and diagnostic information, Internet sources, input from the individual or other caregivers or family members, photographs or videos of the individual (including live images provided via a secure “Webcam” system), mediation information, insurance information, and the like.

The evaluation of the information provided to the processor 80 can be done in light of the base signal 76 and other information, including examination of a time series of biosensor readings 28 from the individual to deduce trends, and so forth. The administrative program can offer a proposed action 122 responsive to the base signal 76 and data from other sensors 118 or other sources 116, which can be implemented immediately when appropriate or can be held pending review of human staff 124 (e.g., physician approval), after which the proposed action 122 or a modified form of the proposed action 122 (or other action responsive to the information provided by the biosensor signal 28 and other data sources 116, 118) is implemented 126.

The proposed action 122 can include modifying a drug being administered to the patient (e.g., decreasing the flow rate of a drug in an intravenous unit that is currently being administered to the individual); calling for emergency treatment; calling for a caregiver to assist the patient; activating additional sensors such as motion detectors, video cameras, oxygen monitors, and so forth; and directing past or live data from these or any other data sources (including the biosensor signal) to be forwarded to a third party such as a physician or diagnostic laboratory, or sending a signal to the individual warning or a potential problem (e.g., blood glucose too low) and requesting appropriate action (e.g., drinking fruit juice). The call for assistance to caregivers or others can also be made via a UWB system, and any data transmitted from the processor and administrative program to other sources can be done by a UWB system or any other means.

The system and method of the present invention may be used for monitoring any number and combination of health conditions. For example, the biosensor elements may be used in the following monitoring scenarios:

detecting the onset of infection or the status of an infection for a recovering patient;

monitoring the health of fetus or mother during pregnancy (pregnancy management), detecting such things as premature delivery by monitoring uterine contractions, antiphospholipid antibodies, fetal fibronectin proteins, and so forth;

monitoring reproductive status (e.g., onset of ovulation or other factors associated with fertility);

other hormone detection (e.g., growth factors, thyroid, menopause-related ones, etc.)

detecting the onset of menstruation;

monitoring analytes associated with renal disease, including analytes in the blood or urine measured before, during, or after dialysis, and analytes measured in any body fluids at home or for patients not receiving dialysis,

monitoring risk factors for osteoporosis, or the onset or status of the disease, or hormone levels or other agents correlated with the development or treatment of osteoporosis and other bone pathologies, through means such as monitoring bone-specific alkaline phosphatase or calcitonin;

monitoring factors related to heart disease, including analytes such as myoglobin, troponins, homocysteine, creatine kinase, thrombus precursor protein, fatty acid binding protein, CRP, and the like;

monitoring factors related to rheumatoid arthritis, including MMP-3, fibrin degradation products, anti-type 11 collagen, and collagen cross-linked N-telopeptides;

detecting factors related to stroke, including D-dimer in the blood or other body fluids;

monitoring the effectiveness or presence of a pharmaceutical agent such as an antibiotic;

detecting an enzyme or other factor associated with heart disease to alert a patient and/or care givers of a potential cardiovascular problem;

identifying rheumatoid arthritis by detecting type I collagen crosslinked N-telopeptides in urine;

monitoring cyanosis or circulatory disorders in newborns, diabetics, and so forth;

monitoring the onset of a sleep apnea episode, coupled with treatments to enhance sleep when needed; such a concept could include the system disclosed in WO 99/34864, published Jul. 15, 1999 by N. Hadas, the U.S. parent of which is incorporated herein by reference;

optically monitoring nail beds as a tool for assessing blood condition (for some tests, nails can be more transparent than skin to changes such as bluing);

tracking body position in a bed and applied pressure against the skin of the patient in order to prevent or care for bedsores (decubitus ulcers) and other ulcers or wounds (one means for tracking applied pressure includes the printed arrays of pressure detecting films marketed by Tekscan, Inc. of South Boston, Mass., which can serve as a sensor indicating pressure applied by the body to various points under the body; videocameras, load cells, and other tools can also be employed for tracking position and load; and position detectors can monitor the level and position of the bed over time to ensure that patient position is regularly adjusted); biosensors indicative of wound health and protein-degrading enzymes can also be employed in cooperative association with pressure and position sensors for this purpose;

tracking indicators of health by monitoring of body odors or analytes in the gas phase near the body, using electronic nose technology or other sensors;

tracking stress with cortisol measurement in saliva or seratonin measurement, including establishing moving baselines to distinguish between acute stress and chronic stress, and optionally relating the time history of measured stress-related analytes to factors that may have induced the stress;

using archived time histories of one or more analytes as a record for identification of sudden changes in the treatment of a subject that may be traceable to changes in personnel, medication, and the like, wherein the time history may serve as a tool in detecting malpractice or other problems, or in verifying (or refuting) claims made by the user regarding health status of the subject;

detecting allergies using as analytes any of IgE (immunoglobulin E), eosinophilic cationic protein, cytokines such as IL-4 or IL-5 in mucous or in the blood or other body fluids, including the use of facial tissue equipped with biosensors for such analytes or with biosensors for bacteria or virus infection;

detecting bacterial infections using analytes such as cytokines (e.g., IL-6), C-reactive protein, calcitonin or pro-calcitonin, CD11b, ESBL enzymes (particularly for drug-resistant bacteria), and lipocalins;

detecting risk factors for cervical cancer by monitoring nuclear matrix protein (NMP) 179 or human papilloma virus from a pap smear;

monitoring levels of taurine in the body or in a local region, including monitoring taurine levels in a non-human mammal such as a domestic cat;

urinary tract infection testing;

yeast infection, bacterial infection, or other forms of vaginitis, including pH imbalance;

UV exposure detection;

nutritional monitoring or detection of nutrient levels, also including hydration monitoring, cholesterol testing, energy assessment, and anemia assessment;

measurement or monitoring of stress indicators;

allergy testing or detection of allergens;

detection or screening for ear infection;

cardiovascular/respiratory health (including pre-heart attack detection, post heart attack detection / monitoring, overall heart health, oxygenation monitoring, pulse, heart dysrythmia alert, respirations, stroke detection, pneumonia detector, respiratory differential, sleep apnea detection);

detection of influenza with devices such as the FLU OIA™ biosensor of Thermo BioStar (Boulder, Colo.), or detection of other diseases with Thermo BioStar biosensor materials;

musculoskeletal testing (muscle performance, osteoporosis, body fat);

monitoring health factors in neonates, such as bilirubin levels for jaundice detection; and

monitoring blood sugar levels for diabetics; and so forth, as set forth in more detail below.

The biosensor transmitters 10 may provide measurements in real time, measurements at periodic intervals (e.g., snapshots in time), time-averaged results, and the like. The biosensor transmitters can be worn on the body or against the body. By way of example, a biosensor transmitter may be placed inside or on an absorbent article such as a bed pad, a diaper, a sanitary napkin, facial tissue, tampon, disposable garment, incontinence product, and so forth. The biosensor transmitters may be placed in containers or receptacles of bodily waste, such as an ostomy bag, bed pan, and the like. It can also be an electrode, optical device, or other instrument, preferably miniaturized, that can respond to health indicators from the subject's body.

In addition to the biosensor reading 28, any number of additional signals (not shown) may be received by the signal converted 14 and combined with the biosensor reading 28 to convey additional information in the output pulse signals 36, or the additional signals can be sent by the biosensor transmitters 10 before or after the output pulse signals 36 pertaining to the biosensor reading 28. In addition or alternatively, any number of additional signals (not shown) may be transmitted to the processor 80 by other means such as via AM or FM radiofrequency signals, direct wiring, the Internet, a modem, and the like. Regardless of how they are transmitted, the additional signals can include readings from other sensors providing measurements of factors such as room temperature, light levels, the location of the individual via a signal from a Global Positioning System (GPS) device or other positioning means, information regarding medications received, operational status of therapeutic devices, the presence of others in the room, whether or not the individual is in bed (e.g., using a load sensor in the bed), and the like. In one embodiment, the presence of specified objects or persons near the individual can be detected by detection means and transmitted with or in addition to the biosensor reading 28 to the processor 80.

For example, objects comprising “smart tags” for radiofrequency identification (RFID), such as the smart tags under development at the Auto-ID Center at Massachusetts Institute of Technology (Cambridge, Mass.) can convey a unique electronic product code via a miniature antenna in response to a radio signal from an RFID reader, which can read the code of the object. The object code can be used to determine the nature of the object. In one embodiment, an RFID scanner associated with the individual reads a plurality of objects in the room and transmits the object codes to the processor 80 or other computer-device that can determine if appropriate or inappropriate objects are present. The product code can be sent via the Intranet or other means to a server containing information relating product codes and object descriptions, which can return the information to the processor 80 or other device or party for evaluation or recoding of relevant information. Inappropriate objects that could be detected could include a pack of cigarettes, a food product to which the individual is allergic, weaponry or other contraband, a person forbidden to have contact with the individual, or electronic devices unsuitable for a patient with a pacemaker. Appropriate objects could include a humidifier, a wheelchair, a caregiver, an oxygen tank, devices to assist walking, and so forth. An RFID reader can also read a unique ID code from a smart tag or other device associated with the individual or the biosensor or both and the code or codes can be sent to the processor 80.

### a. Biosensor Details

The biosensor may be in the form of dedicated hardware for repeat uses, or can be an inexpensive, disposable probe for single use or a small number of repeat uses. The biosensor can be incorporated into an article of clothing or disposable article, and can include any of the biosensor technologies and configurations disclosed in the following U.S. patent applications: Ser. No. 09/299,399, filed Apr. 26, 1999; Ser. No. 09/517,441, filed Mar. 2, 2000; and Ser. No. 09/517,481, filed Mar. 2, 2000, each of which are incorporated herein by reference, the contents of which are believed to have been published at least in part in WO 00/65347, published Nov. 2, 2000 by Hammons et al.; WO 00/65348, published Nov. 2, 2000 by Roe et al.; and WO 00/65083, WO 00/65084; and WO 00/65096, each published Nov. 2, 2000 by Capri et al. The biosensor can also include any of the technologies disclosed in U.S. Pat. No. 6,186,991, issued Feb. 13, 2001 to Roe et al., incorporated herein by reference, and in the U.S. patent applications Ser. No. 09/342,784 and U.S. Ser. No. 09/342,289, both filed Jun. 29, 1999 in the name of Roe et al., both of which are incorporated herein by reference, and both of which are related to the disclosure published as WO 01/00117 on Jan. 4, 2001. The biosensor can also be any of those disclosed in U.S. Pat. No. 5,468,236, issued to D. Everhart, E. Deibler, and J. Taylor, incorporated herein by reference. Additional biosensor technologies and systems are set forth hereafter in this document.

The biosensors used in the present invention can be suitable for use outside of a hospital, such as for home use or use in a managed care facility. Biosensors for any disease or ailment can be considered, including cancer. For example, markers in urine can be detected for bladder cancer (e.g., BLCA-4, a nuclear matrix protein found in the nuclei of bladder cancer cells, a described in Diagnostics Intelligence, v 10, no 5, p.12). Vascular endothelial growth factor and NMP 22 can also be useful analytes. For melanoma, circulating S-100B can be a useful analyte. For prostrate cancer, human glandular kallikrein, prostrate-specific antigen, and E-cadherin can all serve as useful analytes (in the case of E-cadherin, lower levels may be associated with cancer). U.S. Pat. No. 6,200,765, issued Mar. 13, 2001 and incorporated herein by reference, discloses a noninvasive method of detecting prostrate cancer using a body fluid sample, which can be urine. Thus, incontinence products or other absorbent articles could be equipped with biosensors for prostrate cancer, bladder cancer, or other cancers. Feminine care products could also be equipped with biosensors for detecting cervical cancer. One useful marker for cervical cancer is a marker known as NMP-179, (NMP=nuclear matrix protein), which has been linked to cervical cancer by Matritech. Breast epithelial antigen can also be a marker for breast cancer, and has been proposed as an analyte for detection with flexural plate-wave (FPW) sensors. WO 01/20333 discloses a system for cancer detection by detecting midkine in urine or blood. In vitro detection of diseases such as cancer is disclosed in WO 01/20027.

Many biosensors for particular analytes use ELISA (enzyme-linked immunosorbent assays), wherein specific enzyme-labeled antibodies are employed to detect an analyte. Any suitable ELISA method can be employed herein. Solid-substrate assay techniques are typically combined with colorimetric or fluorescent signals to indicate the presence of the analyte, though gravimetric measurement can also be employed. One such example is given by Amy Wang and Richard White at the Berkeley Sensor and Actuator Center, University of Berkeley, described at buffy.eecs.berkeley.edu/IRO/Summary/97abstracts/wanga.1.html, which discloses the use of flexural plate-wave (FPW) sensor wherein the amount of protein bound to the solid substrate (the flexing plate of the FPW device, a micromachined, acoustic sensor along which ultrasonic flexural waves propagate) is measured by a change in acoustic wave velocity caused by the added mass of the bound proteins. Any other measurement technology can be used. Basic principles of immunological sensors are given in P. Tijssen, Practice and Theory of Enzyme Immunoassay, Elsevier, Oxford, 1985, and D. Diamond, Principles of Chemical and Biological Sensors, Wiley and Sons, New York, 1998. Other principles of biosensors employing antibodies are disclosed in WO 01/27621; WO 01/27626; WO 01/27627; WO 01/20329; WO 00/08466; and WO 99/64620.

Biosensors can include multiple sensing elements or other technologies to detect multiple analytes. For example, one can employ the multiple analyte technology of U.S. Pat. No. 6,294,392, “Spatially-Encoded Analyte Detection,” issued Sep. 25, 2001 to Kuhr et al. provides a flow-through microfluidic (e.g., capillary) biosensor for detecting different target analytes (e.g. nucleic acids) in a sample after binding to their cognate “binding partners” (e.g. nucleic acids, antibodies, lectins, etc.). In general, binding partner “probes”, specific to various analytes are immobilized in different sections of a capillary channel, e.g. using photolabile biotin/avidin technology. The sample is then flushed through the capillary, so that the target analytes are bound to the binding partners (capture agents) immobilized on the capillary wall and the rest of the sample is eluted from the capillary. Finally, the complexed (bound) analyte is released along the entire length of the channel and flushed past a detector. In one embodiment, the desorbed, target-analytes are detected at a copper electrode poised downstream using sinusoidal voltammetry (Singhal and Kuhr, Analytical Chemistry, Vol. 69, 1997, pp. 3552-3557; Singhal et al., Analytical Chemistry, Vol. 69,1997, pp.1662-1668). The time from the elution of the target analyte(s) to detection is used to determine the identity of each analyte. Multiple analytes, of the same species of molecule (e.g., all nucleic acids), or of different species (e.g. proteins and nucleic acids), can be diagnosed by using a single biosensor in this manner. The sensor is said to be highly specific due to the use of specific binding partners, and extremely sensitive due to electrochemical detection.

Numerous techniques exist for immobilizing an enzyme or other bioactive material on a substrate. Recent developments include siloxane-based biocatalytic films and paints, in which enzymes are immobilized by sol-gel entrapment of covalent attachment into a polydimethylsiloxane matrix, as described by Y. D. Kim et al., “Siloxane-Based Biocatalytic Films and Paints for Use as Reactive Coatings,” Biotechnology and Bioengineering, Vol. 72, No. 4, 2001, pp. 475-482. Methods for using polytetrafluorethylene (PTFE) substrates have also been developed to enable PTFE use as a polyfunctional support, as described in M. Keusgen et al., “Immobilization of Enzymes on PTFE Surfaces,” Biotechnology and Bioengineering, Vol. 72, No. 5, 2001, pp. 530-540. Elemental sodium and then ozone or peroxide oxidation is used to open up covalent attachment points for enzyme binding. Enzymes can also be immobilized in silica gels, as described by M. Schuleit and P. Luisi, “Enzyme Immobilization in Silica-Hardened Organogels,” Biotechnology and Bioengineering, Vol. 72, No. 2, 2001, pp. 249-253.

Another useful substrate and biosensor is that of Dieter Klemm and Lars Einfeldt, “Structure Design of Polysaccharides: Novel Concepts, Selective Synthesis, High Value Applications,” Macromolecular Symposia, Vol. 163, pp. 35-47, 2001. This discloses polymer matrices useful in biosensors that could be developed by immobilization of enzymes like glucose oxidase and aromatic redox-chromogenic structures at 6-deoxy-6-(4-aminophenyl)-aminocellulose. Also disclosed are p-toluenesulfonic acid esters of cellulose (tosylcelluloses) as intermediates, reacting with 1,4, phenylenediamine (PDA) to form “PDA cellulose.” PDA cellulose esters can then be formed into films onto which enzymes can be immobilized by glutardialdehyde reaction, diazo coupling, an ascorbic acid reaction, or other suitable means, as cited by Klemm and Einfeldt. No enzyme activity is lost within several days, according to the authors. The authors suggest biosensors using fiber optics to convey an optical signal. Redox-chromogenic properties were demonstrated by oxidative coupling reactions of phenols onto the PDA groups in the presence of H2O2 and peroxidase.

Another class of bioanalytical sensor has been developed that instead of using an enzyme to detect its substrate, senses the enzyme directly. This work is described by Michael R. Neuman in the publication, “Biomedical Sensors for Cost-Reducing Detection of Bacterial Vaginosis,” cect.egr.duke.edu/sensors.html, reporting work supported by NSF grant #9520526 and the Whitaker Foundation. Any suitable immunosensor and method of making the same can be used, including those of N. Trummer, N. Adányi, M. Váradi, I. Szendrö in “Modification of the Surface of Integrated Optical Wave-Guide Sensors for Immunosensor Applications,” Fresenius Journal of Analytical Chemistry, Vol. 371, No.1, August 2001, pp. 21-24, who disclose methods for attaching amino and epoxy groups to the surface of integrated optical wave-guide sensors for immunosensors. The SiO₂—TiO₂ surfaces were modified by use of the trifunctional silane reagents.

Lateral flow or immunochromatographic technology in any suitable form can be used in the biosensors as well. For example, Quidel (San Diego, Calif.) offers a variety of lateral flow devices that can be used in the present invention, including the QuickVue H.pylori gII test, which is a lateral-flow immunochromatographic assay intended for rapid detection of IgG antibodies specific to Helicobacter pylori in human serum, plasma or whole blood.

Biosensors can also function based on other scientific principles suitable for detection of analytes, including surface plasmon resonance (SPR), phase fluorescence, chemiluminescence, protein nucleic acid (PNA) analysis, baculovirus expression vector systems (BEVS), phage display, and the like. Examples of sensors incorporating such principles can be found in many sources, including the products of HTS Biosystems, such as their Proteomatrix™ Solution for proteomics. Basic information is provided at http://www.htsbiosystems.com/technology/spr.html. For example, HTS Biosystems' FLEX CHIP™ Kinetic Analysis System is based on grating-coupled SPR technology wherein measurements are made of optical properties of a thin film in close to a noble metal surface (e.g., gold or silver). Changes in molecular composition (e.g., when a target binds to a surface-bound capture probe) cause changes in the surface optical properties that are proportional to the amount of binding that occurs. The manufacturers state that this technology can be considered, in a way, to allow monitoring of surface-binding events in real time without the use of reporter labels. Grating-coupled SPR-based disposable biosensor chip can be made employing the technology currently used in producing digital video disc (DVD) media. An optical grating on a plastic base is produced. Amperometric immunosensors can also be used, such as those being developed at the Paul Scherrer Institute of Villigen, Switzerland, as described at Imn.web.psi.ch/molnano/immuno.htm. Biorecognition, the binding of antibodies to an antigen, for example, results in an electrical signal at an electrode. Antibodies are labeled with microperoxidase for generation of an electrochemical signal via electrocatalytic reduction of hydrogen peroxide.

Many forms of electrodes can be incorporated in the biosensors of value in the present invention. The electrodes can be created with photolithography, printing technologies such as ink-jet or screen printing, mechanical assembly, any technique suitable in the production of semiconductor chips, and the like. An example of screen-printed sensor is found in the work of A. J. Killard, et al. of Dublin City University, “A Screen-printed Immunosensor Based on Polyaniline,” described at www.mcmaster.ca/inabis98/newtech/killard0115/ and www.mcmaster.ca/inabis98/newtech/killard0115/two.html. Chips in biosensors can also include optical devices. For example, Motorola has developed a silicon chip integrated with a photon chip in which light-emitting gallium arsenide is bonded with strontium titanate to silicon (see Bill Scanlon, “Motorola Solves 30-Year Optical-Silicon Chip Puzzle,” Interactive Week, Sep. 10, 2001, p. 18). Similar technology is being applied to bond light-emitting indium phosphide to silicon. Both approaches can be adapted for biosensors in which a chip generates and measures an optical signal that interacts with a medium to detect an analyte. Chips can also include light emitting diodes, diode lasers, or other light-emitting devices for biological sensing, as described, for example, in S. Dorato and A. Ongstad, “Mid-Infrared Semiconductor Laser Materials Engineering,” AFRL Technology Horizons, Vol. 2, No. 3, September 2001, pp.14-15. Semiconductor lasers can generate beams in the near-IR spectral region (700-1000 nanometers). Blue-green light can also be generated by semiconductor lasers, such as those based on III-V gallium nitrogen and II-VI zinc-sulfur compounds, which emit radiation in the range of 490 to 55 nanometers. Long wavelength diodes can also be used, with infrared radiation in the range of 2000 to 12,000 nanometers. Mid-IR devices, including tunable mid-IR semiconductor lasers, can also be used, as well as quantum-well lasers (e.g., a “W-laser”) and antimonide lasers.

Numerous biosensor chips can be used in the present invention, including those providing miniaturized, microfluidic assay chemistries. Exemplary devices are described in the article “Biochips” in Nature Biotechnology, Vol.16, 1998, pp. 981-983, which also describes several examples of protein biochips, particularly the Affymetrix GeneChips. The p53 GeneChip, designed to detect single nucleotide polymorphisms of the p53 tumor-suppressor gene; the HIV GeneChip, is designed to detect mutations in the HIV-1 protease and also the virus's reverse transcriptase genes; and the P450 GeneChip focuses on mutations of key liver enzymes that metabolize drugs. Affymetrix has additional GeneChips in development, including biochips for detecting the breast cancer gene, BRCA1, as well as identifying bacterial pathogens. Other examples of biochips used to detect gene mutations include the HyGnostics modules made by Hyseq. Examples of biochips designed for gene expression profile analysis include Affymetrix's standardized GeneChips for a variety of human, murine, and yeast genes, as well as several custom designs for particular strategic collaborators; and Hyseq's HyX Gene Discovery Modules for genes from tissues of the cardiovascular and central nervous systems, or from tissues exposed to infectious diseases.

A wide variety of biosensor chips are provided by Biacore International AB (Uppsala, Sweden). Products are described at www.biacore.com/products/chips_all.shtml. In an example disclosed in the document at www.biacore.com/company/pdf/poster_ahm_use.pdf, a Biacore 3000 sensor was used to track the interaction of two enantiomers of a drug with human albumin. From this one can infer that real-time monitoring can be done of the interaction of a pharmaceutical agent with blood to assess the effectiveness of the drug. For example, a drug can be administered to the patient and a biosensor can then track the state of the drug in the blood to better guide application of the drug to the patient.

Another example is Caliper's LabChip, which uses microfluidics technology to manipulate minute volumes of liquids on chips. Applications include chip-based PCR as well as high-throughput screening assays based on the binding of drug leads with suitable drug targets.

In addition to suitable DNA and RNA-based chips, protein chips are being developed with increasing frequency. For example, a recent report describes the development of a quantitative immunoassay for prostate-specific membrane antigen (PSMA) based on a protein chip and surface-enhanced laser desorption/ionization mass spectrometry technology. Some protein biochips employ surface plasmon resonance (SPR). V. Regnault, et al. in British Journal of Haematology, Vol. 109, 2000, pp. 187-194 disclose the use of SPR to detect the interaction between autoantibodies and 2-glycoprotein I ( a2GPI) immobilized on protein sensor chips, an interaction correlated with lupus. SPR enabled the interaction to be detected at a very low density of protein immobilization on the chip.

Microcantilevers and quartz crystals can serve as sensing elements for the detection of particular analytes, as described by C. Henry, “Biosensors Detect Antigens, Viruses,” Chemical and Engineering News, Vol. 79, No. 37, Sep. 10, 2001, p. 13. For example, G. Wu et al. in “Bioassay of Prostate-Specific Antigen (PSA) Using Microcantilevers,” Nature Biotechnology, Vol. 19, No. 9, September. 2001, pp. 856-60, describe a sensitive microdevice employing microcantilevers that detects the presence of prostrate-specific antigen, a marker for early detection of prostrate cancer and for monitoring its progression. PSA antibodies are attached to a gold-coated silicon nitride microcantilever. Fluid passing over the device brings PSA, which binds to the antibodies, causing a change in the deflection of the microcantilever that can be measured by a laser. Levels of 0.2 ng/ml were detectable, even in a background of unrelated human serum proteins. The threshold for cancer detection of 4 ng/ml. Arrays of microcantilevers are possible, and could be employed to detect a plurality of analytes.

Quartz crystal microbalances (QCMs) have been used to detect viruses that bind to antibodies on the surface of the quartz, as described by M. A. Cooper, “Direct and Sensitive Detection of a Human Virus by Rupture Event Scanning,” Nature Biotechnology, Vol. 19, No. 9, September 2001, pp. 833-37. As the quartz crystal is oscillated an increasing frequencies in the presence of an alternating electrical field, a critical frequency is reached where the virus-antibody bond is ruptured. The quartz crystal, acting like an acoustic device, converts the acoustic emission from the bond rupture to an electrical signal. Proteins that are less strongly attached to the crystal are shaken off early during oscillation, allowing the device to distinguish between specific and non-specific adsorption.

A particularly sensitive class of microsensors includes acoustic sensors, such as those using surface acoustic wave (SAW), bulk acoustic wave (BAW), and acoustic plate modes (APM). Selectivity is typically achieved by coating a thin polymeric or metallic film on the sensing surface of the piezoelectric crystal. The polymer may be organic, inorganic or organometallic. Acoustic wave chemical sensors and biosensors thus consist of a piezoelectric crystal device and a chemical system attached to the crystal surface. The chemical system consists of the polymeric coating and/or chemoreceptors attached to the coating. The chemical system is used as a molecular recognition element and has the ability to selectively bind molecules and gas particles. While the physics of the detection process is very complex, the principle of operation of acoustic wave device sensor is quite simple and the results are reliable. An acoustic wave confined to the surface (SAW) or bulk (BAW) of a piezoelectric substrate material is generated and allowed to propagate. Any matter that happens to be present on the crystal surface will perturb that surface in such a way as to alter the properties of the wave (i.e. velocity or frequency, amplitude or attenuation). The measurement of changes in the wave characteristics is a sensitive indicator of the properties of the material present on the surface of the device. In general, it is well known that both mechanical and electrical perturbations of the surface affect the propagating acoustic waves and result in sensing. Such perturbations result from the absorption or diffusion of gas into the film; molecule selectivity, migration or binding; and formation of complexes within the film.

A useful example of a piezoelectric sensor is given in U.S. Pat. No. 5,852,229, “Piezoelectric Resonator Chemical Sensing Device,” issued Dec. 22, 1998 to Josse and Everhart, incorporated herein by reference. Josse and Everhart disclose a sensor including a piezoelectric resonator having a first side with an electroded region and a second opposing side having an electroded region that is different in size and/or shape of the first electrode. The piezoelectric resonator of the present invention is capable of measuring more than one parameter thereby providing a multi-information-sensing device. The present invention also includes an apparatus and method for detecting and measuring an analyte in a medium that utilizes the piezoelectric resonator sensor of the present invention.

### (1) Diffraction-Based Technologies

A variety of diffraction-based technologies can be employed in making low-cost biosensors. For example, U.S. Pat. No. 5,922,550, “Biosensing Devices Which Produce Diffraction Images,” issued Jul. 13, 1999 to Everhart et al., incorporated herein by reference, discloses a disposable biosensor which can be used to detect many analytes. The device includes a metalized film upon which is printed a specific predetermined pattern of analyte-specific receptors. Upon attachment of a target analyte, which is capable of scattering light, to select areas of the plastic film upon which the receptor is printed, diffraction of transmitted and/or reflected light occurs via the physical dimensions and defined, precise placement of the analyte. A diffraction image is produced which can be easily seen with the eye or, optionally, with a sensing device. By “diffraction” it is meant the phenomenon, observed when waves are obstructed by obstacles, of the disturbance spreading beyond the limits of the geometrical shadow of the object. The effect is marked when the size of the object is of the same order as the wavelength of the waves. In the U.S. Pat. No. 5,922,550 patent, the obstacles are analytes and the waves are light waves.

Everhart et al. in U.S. Pat. No. 5,922,550 employ methods of contact printing of patterned, self-assembling monolayers of alkanethiolates, carboxylic acids, hydroxamic acids, and phosphonic acids on metalized thermoplastic films, the compositions produced thereby, and the use of these compositions. The self-assembling monolayers have receptive materials bound thereto. The receptive materials are specific for a particular analyte or class of analytes depending upon the receptor used.

Patterned self-assembling monolayers allow for the controlled placement of analytes thereon via the patterns of analyte-specific receptors. The biosensing devices of the present invention produced thereby are used by first exposing the biosensing device to a medium that contains the analyte of choice and then, after an appropriate incubation period, transmitting a light, such as a laser, through the film. If the analyte is present in the medium and is bound to the receptors on the patterned self-assembling monolayer, the light is diffracted in such a way as to produce a visible image. In other words, the patterned self-assembling monolayers with the analyte bound thereto can produce optical diffraction patterns that differ depending on the reaction of the receptors on the self-assembling monolayer with the analyte of interest. The light can be in the visible spectrum, and be either reflected from the film, or transmitted through it, and the analyte can be any compound or particle reacting with the self-assembling monolayer. The light can be a white light or monochromatic electromagnetic radiation in the visible region. The present invention also provides a flexible support for a self-assembling monolayer on gold or other suitable metal or metal alloy.

Everhart et al. in U.S. Pat. No. 5,922,550 further disclose a support for a self-assembling monolayer on gold or other suitable material which does not require an adhesion promoter for the formation of a well-ordered self-assembling monolayer. They also disclose a support for a self-assembling monolayer on gold or other material that is suitable for continuous printing, rather than batch fabrication, allowing the device to be mass produced. Their biosensor can be produced as a single test for detecting an analyte or can be formatted as a multiple test device, and can be used to detect contamination in garments, such as diapers, and to detect contamination by microorganisms.

### (2) I-Stat Biosensors

Useful biosensors for the present invention are exemplified by several of the products of i-STAT Corporation (East Windsor, N.J.). The I-STAT System uses micro-fabricated thin film electrodes as electrochemical sensors whose signals can be measured and quantified with the I-STAT Portable Clinical Analyzer's amperometric, pontentiometric, or conductometric circuits. Solution for calibrating the electrodes is provided in a foil pouch within the measurement cartridge. During measurement of either the calibrating solution or a blood sample, the fluid being measured flows over a sensor array for measurement. Measurements are made by ion-selective electrode potentiometry for sodium, potassium, chloride, ionized calcium, pH, and pCO₂. Also measured are urea (after hydrolysis to ammonium ions by urease), glucose (amperometric measurement of hydrogen peroxide produce from glucose by the enzyme glucose oxidase); pO₂ (using an electrode similar to a conventional Clark electrode, with oxygen diffusing from the blood through a gas permeable membrane into an internal electrolyte solution, where it is reduced at a cathode to generate a current), and hematocrit (measured conductometrically). Additional results can be calculated for HCO₃ (bicarbonate), TCO₂ (total carbon dioxide, the sum of the carbonic acid and bicarbonate levels), BE (base excess), sO₂ (saturated oxygen), anion gap and hemoglobin.

Several biosensor technologies are disclosed in a U.S. patent assigned to I-Stat Corp., No. U.S. Pat. No. 5,063,081, “Method of Manufacturing a Plurality of Uniform Microfabricated Sensing Devices Having an Immobilized Ligand Receptor,” issued Nov. 5, 1991 to Cozzette et al., incorporated herein by reference. Disclosed therein are wholly microfabricated biosensors having a plurality of thin films and related structures over a planar wafer. The sensors employ biologically active macromolecules and other reagents necessary for the conversion of selected analyte molecules to more readily detectable species, typically using electrochemical assay procedures for determining the presence and/or concentration of biological species (analytes) of interest. A substrate is used that does not undergo detectable electrochemical oxidation or reduction but which undergoes a reaction with a substrate converter producing changes in the concentration of electroactive species. These changes are measured and related proportionately to the concentration of the analyte of interest. The substrate converter can be an enzyme that hydrolyzes the substrate. This hydrolyzed substrate can then undergo reactions which produce changes in the concentration of electroactive species (e.g., dioxygen and hydrogen peroxide) which are electrochemically detected with the biosensor, e.g., a ligand/ligand receptor-based (LLRbased) biosensor in this instance. Both sandwich and competitive assays can be used.

In one immunoassay system disclosed by Cozette et al., a biosensor includes a catalytic electrode and optional reference electrode (base sensor), an adhesion promoter layer overlaid on the biosensor, and a bioactive layer that is immobilized on the adhesion promoter layer, which bioactive layer is a receptor (first member) of the immunological analyte of interest. The wholly microfabricated biosensor includes a wafer on which a first structure including a suitable base sensor is established. Additional structures are then established over the resulting base sensor, which additional structures include a semipermeable solid film or permselective layer capable of acting as a barrier against interfering chemical species while allowing the transport of smaller detectable chemical moieties of interest. These detectable chemical moieties are typically electroactive molecules and may include low molecular weight ionic species. The semipermeable solid film may further include compounds or molecules that may serve to sensitize the base sensor to a preselected ionic species (e.g., ammonium ion). Furthermore, such permselective layers may also function as adhesion promoters by which the preselected ligand receptor may be immobilized to the wholly microfabricated LLR-based biosensor embodiment of the present invention. The support matrices described by Cozette at al. can possess or support the physical and chemical features necessary for converting the particular analytes in a given analytical sample into detectable and/or quantifiable species. Techniques are disclosed for localizing or patterning said matrices on certain desired areas of the wholly microfabricated biosensor which allow for the optimum control over dimensional features of the biolayers as well as the versatility to accommodate a wide range of bioactive molecules. Additionally, the overlaid structures can be provided for the attenuation of the transport of selected analyte species that are present in high concentrations in the sample. Such analyte attenuation (AA) layers allow for a linear sensor response over a wider range of analyte concentrations than would be observed in the absence of an AA layer. Furthermore, the overlaid AA layer, which can be derived from a siloxane/nonsiloxane copolymer, is capable of excluding very large molecules or other contaminating constituents of the sample whose direct contact with the underlying structures would result in interference with or fouling and an eventual reduction in the reliability of the biosensor. If the AA layer is of the appropriate structure and composition, it may also function as a gas permeable membrane. In certain embodiments, such a gas permeable membrane can allow only very small molecules to pass through. The gas permeable membrane also insulates the immediate environment of the electrode portion of the biosensor from external fluid turbulence. Thus, the measurements performed by the preferred LLR-based sensor can be rendered substantially free of flow dependence.

Apart from the AA layer mentioned above, a semipermeable solid film that is able to function as a molecular weight-sensitive transmissive film is among the layers. Depending upon the composition and final thickness of this semipermeable solid film, also referred to as a permselective layer, molecules having molecular weights above a given threshold can be effectively excluded from entering and diffusing through such a film. As a general illustration of the function and utility of this permselective layer, molecules having a molecular weight of about 120 or above are effectively blocked by a solid film having a thickness of about 5 to about 10 nm. Varying degrees of control over the size of the molecules excluded and the rates of transport of smaller molecules which are able to diffuse through the solid film can be obtained with solid films having a thickness in the range of about 2 to about 50 nm. With certain types of materials, these permselective layers may be as thin as 1 nm or may be as thick as 100 nm. This film may be established on the substrate wafer or any planar analyte-sensing device in a number of ways but most conveniently as an initial liquid film, including a silane compound mixed with a suitable solvent, which is spin-coated across the wafer. If desired, the permselective layer may be formed at specific preselected areas of the device by means of photolithographic processing techniques. Techniques such as “lift-off” and use of a photoresist cap in combination with a plasma-etching or, alternatively, a wet-etching step may thus be employed to define the location and configuration of the semipermeable solid film. The initial liquid silane mixture, like many other liquid mixtures of use in the present invention, can also be microdispensed at multiple preselected areas of the sensing device. Such microdispensing of fluid media may be performed automatically and in uniform predetermined quantities by a computer-controlled syringe interfaced with the controlled movements of a vacuum chuck holding the substrate wafer. Such microdispensing techniques are consistent with a microfabrication method and are discussed in further detail in Cozette et al. Thus, in an amperometric electrochemical sensing device, interfering electroactive species having a molecular weight above a desired threshold (e.g., above 120) may effectively be excluded from interacting with the catalytic electrode surface by employing a permselective layer that still allows lower molecular weight electroactive species, like dioxygen and hydrogen peroxide, to undergo a redox reaction with the underlying electrode surface.

### (3) Hormone and Pregnancy-Related Sensors

Biosensors may be used to assist in hormone therapy used, for example, to prevent or treat osteoporosis or other problems. The balance of hormones applied may need to change over time, and the correct balance may be inferred from biosensors responsive to hormone levels in the blood or other indicators such as bone mineral density or other chemical analytes. In response to a biosensor signal, for example, a physician may modify the hormone balance provided to a patient. The adjusted medication may be ordered electronically from a pharmacy, and the medication may be delivered to the subject or provided by a nurse or other caregiver.

Direct detection of enzymes in biosensors can be useful in many aspects of health care, particularly for feminine care and pregnancy monitoring. The enzyme-detection sensors referred to in the above-mentioned work of Neuman can be of particular value. Neuman observes that since diamineoxidase is found in amniotic fluid, this type of sensor may also be useful in detecting premature rupture of membranes with leakage of fluid when conventionally used techniques provide equivocal results. A preliminary design for an intervaginal probe has been reduced to practice and investigators are designing a probe that will contain 4 pH sensors for mapping intervaginal pH. Such probes can be used within the scope of the present invention.

Such devices can employ both a potentiometric pH sensor and an amperometric diamine sensor to aid in vivo diagnosis of bacterial vaginosis (BV). Techniques are known to make single-site diamine sensors on a flat-form, self-contained sensor substrate that has been batch-fabricated on a flexible polyimide layer.

For pregnancy monitors to predict a possible premature delivery, several options are available. Recent work has shown that electrodes can detect early contractions of the uterus days or weeks in advance of delivery to signal the onset of labor (see New Scientist, Mar. 2, 2001). Thus, electrodes placed on an expecting mother could be used to monitor contractions well before the onset of delivery.

A pad that can be worn by a woman to detect premature delivery is disclosed in WO 00/04822 or EP 1,098,590.

Biochemical means can also detect the onset of delivery in advance. George C. Lu et al. in “Vaginal Fetal Fibronectin Levels and Spontaneous Preterm Birth in Symptomatic Women,” Obstetrics and Gynecology, Vol. 97, No. 2, February 2001, pp. 225-228, incorporated herein by reference, establish that detection of fibronectin in the vagina is an indicator of preterm birth. Fibronectin is a protein produced by the chorioamniotic membranes and apparently serves as a biological glue that maintains the integrity of structures in the womb. Lu et al. review evidence that disruption of those structures (the chorionicdecidual interface) precedes preterm labor and causes the release of fetal fibronectin into the cervicovaginal fluid. Several technologies exist for detection of fibronectin that could be adapted for a disposable home-use biosensor. Those of Adeza Corp., for example, can be used.

Other analytes related to premature rupture of the amniotic membrane include hCG, IGFBP-1, alpha FP, and diamine oxidase. Further, monitoring of nitrate and nitrite levels in the body can be correlated with premature delivery. Sensors useful for these analytes are described hereafter. Prolactin can also be monitored as an indicator of premature labor. For prolonged pregnancy, fetal fibronectin biosensors can again be useful.

U.S. Pat. No. 6,149,590, incorporated herein by reference, discloses the use of pH sensitive paper, including nitrazine paper, that is liquid permeable, for identification of premature membrane rupture in pregnancy. Amniotic fluid changes the color of the paper. This can be incorporated into a sanitary napkin.

Estriol, alpha fetoprotein, human chorionic gonadotropin (hCG), and inhibin-A are other analytes of value in pregnancy monitoring.

Antiphospholipid Syndrome (APS) is a health problem affecting many women. The presence of antiphospholipid antibodies in the body is often associated with pregnancy loss, and APS also can cause thrombosis in veins or arteries of the woman, as discussed by N. B. Chandramouli and G. M. Rodgers in “Management of Thrombosis in Women with Antiphospholipid Syndrome,” Clinical Obstetrics and Gynecology, Vol. 44, No.1, 2001, pp. 36-47. W. Geis and D. W. Branch discuss antiphospholipid antibodies and their relationship to pregnancy loss in “Obstetric Implications of Antiphospholipid Antibodies: Pregnancy Loss and Other Complications,” Clinical Obstetrics and Gynecology, Vol. 44, No. 1, 2001, pp. 2-10.

APS can be detected by immunoassay tests or other tests, as described by S. S. Pierangeli, A. E. Gharavi and E. N. Harris in “Testing for Antiphospholipid Antibodies: Problems and Solutions,” Clinical Obstetrics and Gynecology, Vol. 44, No.1, 2001, pp. 48-57. It is often desirable to verify the presence of the syndrome by using two different tests. Immunologic assays can be used that directly detect antiphospholipid antibodies or to detect LA or related proteins. Enzyme-Linked immunosorbent Assay (ELISA) systems can also be used.

Another useful marker may be human chorionic gonadotropin (hCG), which is usually used to determine whether a woman is pregnant. In addition, however, this marker can continue to be monitored as an indicator of the health of the fetus. TPS can also be monitored.

Noninvasive optical sensors can also be used to pass light through the abdomen of the mother and reach the fetus, allowing measurement of blood oxygen levels with pulse oximetry, as described in N. D. Rowell, “Light Could Help Doctors Draw Less Blood,” Photonics Spectra, September 2001, pp. 68-72. See also A. Zourabian et al., “Trans-abdominal Monitoring of Fetal Arterial Blood Oxygenation Using Pulse Oximetry,” Journal of Biomedical Optics, October 2000, pp. 391-405.

Biosensors according to the present invention can be used for monitoring of folic acid in pregnant women or in women planning to become pregnant. A particular challenge exists for many of those who have used oral contraceptives, where folic acid levels are often low and body reserves have been depleted. It has been recommended that these women wait for several months to regain the folic acid levels needed for a healthy pregnancy. Monitoring of folic acid levels in the body can be helpful in preparing for a healthy pregnancy and maintaining health of the mother and fetus during pregnancy.

In addition to monitoring folic acid in the body, in some cases it may be desired to monitor intake of folic acid with suitable sensors. Biacore sensors, among others, can be used for this application. T. A. Grace et al. of Biacore describe the use of a surface plasmon resonance sensor (Biacore Q sensor system) for folic acid determination in the paper, “The Determination of Water-Soluble Vitamins in a Variety of Matrices by Biacoreq Assay Kits,” Institute of Food Technologists Annual Meeting, June 2001, New Orleans (abstract available at ift.confex.com/ift/2001/techprogram/paper_{—}9594.htm—see also www.biacore.com/customer/pdf/vol2no2/22p22.pdf). Samples of foodstuffs can be blended, ground, and optionally centrifuged in the preparation of extracts suitable for direct measurement of folic acid levels with sensors. Another example of a Biacore biosensor system for folic acid determination is described by M. Boström-Caselunghe and J. Lindeberg, “Biosensor-Based Determination of Folic Acid in Fortified Food,” Food Chemistry, Vol. 70, 2000, pp. 523-32.

A marker of use in predicting ectopic pregnancy is “smhc Myosin,” as well as serum progesterone.

Pre-eclampsia (formerly known as “toxemia”), a hypertensive disorder of pregnancy associated with proteinuria and pathologic edema, may be tracked by monitoring protein in the urine or other factors.

Numerous home test devices exist for detecting pregnancy or the onset of ovulation, any of which can be adapted for the, present invention. Basal temperature measurements and urine LH (luteinizing hormone) kits represent two common technologies. Monitoring Follicle Stimulating Hormone with biosensors in absorbent articles to track the onset of ovulation is suggested in the following U.S. patent applications: Ser. No. 09/299,399, filed Apr. 26, 1999; Ser. No. 09/517,441, filed Mar. 2, 2000; and Ser. No. 09/517,481, filed Mar. 2, 2000; each of which was previously incorporated by reference.

Biosensors for fertility monitoring and the detection of ovulation include those of Thermo BioStar, Inc. (Boulder, Colo.); the TFS estradiol metabolite BioSensor of ThreeFold Systems, Inc. (Ann Arbor, Mich.); the OvuSense biosensor of Conception Technology Inc. (Longmont, Colo.); and Pheromone Sciences Corp. (Toronto, Canada), whose PSC Fertility Monitor is worn like a watch and uses non-invasive measurement of ions on the skin. The PSC Fertility Monitor incorporates an interactive microprocessor combined with a biosensor enabling it to take up to 12 daily measurements from the skin surface and to evaluate the data in order to predict the status of the user as being not-fertile, fertile, or ovulating. Results can be viewed at any time on the LCD screen of the device or as a computer-generated graphical printout for medical professionals. Further examples include U.S. Pat. Nos. 6,234,974 and 5,656,503 assigned to Unilever, and WO 99/10742 assigned to Fertility Acoustics.

### (4) Sensors for Vaginosis

Biosensors can also be used for the detection of yeast vaginitis or bacterial vaginitis. Sensors can respond to pH changes associated with such conditions, and can also detect another physical or chemical condition, such as the presence of a diamine, for increased accuracy. Exemplary biosensors include those developed by Michael R. Neuman, as described in the publication, “Biomedical Sensors for Cost-Reducing Detection of Bacterial Vaginosis,” available on the Internet at cect.egr.duke.edu/sensors.html, reporting work supported by NSF grant #9520526 and the Whitaker Foundation. Such sensors are based on thin-films on polyimide microstructures. These sensors can also be used to detect pH changes associated with premature rupture of amniotic membranes and the release of amniotic fluid. In one embodiment described therein, the enzyme layer was immobilized on the working electrode surface by crosslinking putrescine oxidase (PUO) with bovine serum albumin using glutaraldehyde. The three-electrode sensor prepared was sensitive to putrescine.

A pH-based method for distinguishing between yeast infections and other secretion-causing conditions employing a color-changing sensor in an absorbent article is disclosed in U.S. Pat. No. 5,823,953, issued Oct. 20, 1998 to Roskin et al., incorporated herein by reference. The sensor and/or article of Roskin can be used within the scope of the present invention.

Bacterial pathogens can be tracked by monitoring vaginal pH (e.g., using biosensors from Litmus Concepts, Inc. of Santa Clara, Calif.), ECA, or alpha antigen, or by other suitable techniques. Lactoferrin is another biological analyte related to vaginosis that can be monitored with biosensors. Detection of proline aminopeptidase or other amines can be achieved using biosensors from Litmus Concepts, Inc. and applied to vaginosis tracking.

Volatile Organic Compounds (VOCs) produced by the bacteria and yeast associated with vaginosis can also be detected with biosensors to detect vaginosis and monitor healing. Vaginosis is usually due to a change in the balance among different types of bacteria in the vagina. Instead of the normal predominance of Lactobacillus, increased numbers of organisms such as Gardnerella vaginalis, Bacteroides, Candida, Mobiluncus, and Mycoplasma hominis are found in the vagina in women with vaginosis.

The most common vaginitis in women is caused by Candida albicans. Almost every woman experiences a yeast infection at some point in her life and many women are plagued by recurring episodes of vaginal yeast infections. There are several different strains of Candida which are implicated with vaginosis. The most common symptoms of this type of vaginosis are a thick white discharge and intense itching and sometimes burning, both inside and outside the vagina. There may at times be an odor, but this is not usually considered the primary symptom. In one embodiment, the biosensor monitors odors specifically produced by C. albicans as a marker for vaginitis.

The bacteria Gardnerella is almost as common as yeast infections. Again, it is possible to monitor odors specifically produced by Gardnerella as a predominance marker for association with vaginitis. Another vaginal infection that is less common is Trichomonas. This protozoan infection is usually sexually transmitted. Again, it is possible to monitor odors specifically produced by Trichomonas as a marker for vaginitis.

Traditionally, diagnoses for vaginosis are made microscopically. A vaginal infection can be precisely identified by a three-minute, three-step testing procedure on a single sample of vaginal discharge. The testing requires pH paper, potassium hydroxide, saline solution, and a microscope. The draw back of this procedure is that it requires trained medical professionals to complete the diagnosis. A rapid simple measure available to the consumer would allow for more timely treatment of vaginosis and a benefit to public health.

Anaerobic and facultative bacteria that normally live on and in the skin as well as on and in mucus membranes commonly cause odors. Anaerobic growth of these organisms requires an organic compound as a terminal electron (or hydrogen) acceptor. Simple organic end products are formed from the anaerobic metabolism of carbohydrates and/or some other compound. The simple organic end products formed from this incomplete biologic oxidation process also serve as final electron and hydrogen acceptors. Upon reduction, these organic end products are secreted by the bacterium as waste metabolites. Many of these compounds are VOCs. Thus, a biosensor can monitor these VOCs allowing for the identification of the type of microbe infecting the vagina and associated vaginosis. It has been established that the type and pattern of VOCs produced by microbes can be associated with specific classification.

Micro-arrays can be employed to detect the volatiles. Arrays of electronic sensors (e.g., electronic nose technology), capable of detecting and differentiating complex mixtures of volatile compounds, have been utilized to differentiate aromas of food and related materials. Electronic nose technology can contain an array of sensors, using a variety of different sensor technologies. Conducting polymer sensors are the most common sensors, as exemplified by the devices of the University of Warwick (Coventry, England), Neotronics Scientific Ltd. (Bishops Stortford, England), AromaScan Inc. (Hollis, N.H.), and Cyrano Sciences, Inc. (Pasadena, Calif.). Oligomeric sensors are reportedly stable, durable, and easy to use, such as the devices studied at the University of Antwerp. Metal oxide sensors are inexpensive to produce and said to be simple to operate, exemplified by the diAGnose agricultural sensor of Texas A&M University and gas sensor chips from Hong Kong University of Science & Technology. Quartz microbalance technology has also been used to develop an indicator system that responds to a wide range of compounds, as demonstrated at Griffith University (Brisbane, QLD), and RST Rostock (Warnemunde, Germany). Electronic nose technology is also described by T. -Z. Wu, “A Piezoelectric Biosensor as an Olfactory Receptor for Odour Detection: Electronic Nose,” Biosensors and Bioelectronics, Vol. 14, 2000, pp. 9-18. Another sensor for detecting chemicals in the gas phase is the chemical sensor badge developed by Nicholas L. Abbott, a professor of chemical engineering at the University of Wisconsin, and Rahul R. Shah of 3M Corporation, as reported in the NASA Tech Briefs Sensors Newsletter of Sep. 19, 2001. These sensors do not require electrical power, and provide direct visual indications of the presence of a chemical. Designed using nanotechnology, they use microscopic liquid crystals attached by a few molecules of a chemically receptive substance to a thin film of gold. When the substance is exposed to chemicals, it bonds to the targeted chemical, and loosens its grip on the liquid crystal. The crystals take on a new orientation controlled by the texture of the gold surface, and the result is visible as a change in the sensor's brightness or color. The substrate can be a flexible polymeric material that is fastened to the outside of an article of clothing. Multiple sensors for multiple analytes could be used.

One useful multi-analyte sensor is disclosed by C. Hagleitner et al. in “Smart Single-Chip Gas Sensor Microsystem,” Nature, Vol. 414, 2001, pp. 293-96. They disclose a smart single-chip chemical microsensor system that incorporates three different transducers (mass-sensitive, capacitive, and calorimetric), all of which rely on sensitive polymeric layers to detect airborne volatile organic compounds. Full integration of the microelectronic and micromechanical components on one chip permits control and monitoring of the sensor functions, and enables on-chip signal amplification and conditioning that notably improves the overall sensor performance. The circuitry also includes analog-to-digital converters, and an on-chip interface to transmit the data to off-chip recording units. This technology may be applied to produce improved noses or other gas-phase sensors, which can also be used in cooperation with liquid-phase or other sensors to simultaneously examine a wide variety of analytes.

The applications of these arrays to detect VOCs produced by problem microbes require that the array be modified to detect the compounds specific to those organisms. Compounds that can be monitored include, without limitation, oxalacetic acid, pyruvic acid, malonic acid, lactic acid, formic acid, acetic acid, fumaric acid, caproic acid, dimethyl disulfide, ammonia, acetone, isovaleric acid, and triethylamine. The biosensor signal can include a stand-alone chip that is placed in a non-woven, coform, or cellulosic material such that the signal is either generated as a color change or electronic voltage.

### (5) Other Women's Health Issues

Biosensors can also be used to detect the onset of menopause and track a woman's health after menopause. Useful biological markers for these purposes include transferrin, serum ferritin, inhibins A and B (e.g., using technologies of DSL, Inc.), FSH, estradiol, inflammatory cells, MMPs, and reproductive hormones. Ferritin and hemoglobin can be tracked to assess iron status during menstruation. Nitrogen oxides can also be tracked to assess menstrual homeostasis. Bone reabsorption or osteoporosis can be related to monitored levels of CA-125, osteocalcin, C-telopeptide from collagen, pyridinole and deoxypyridinole, etc. Endometrial health can be related to desmin, CEA, PP10, P12, PP14, and PP15, while endometriosis can be monitored via CD23, perforin, Grannzyme B, CA-125, CA72-4, CA19-9, MMP-7, MMP-9, and TIMP.

Ovarian dysfunction can be related to measurements of anti-corpus leuteum antibodies, CA-125, estradiol, and testosterone. Cervical health can be related to mucous glycoconjugates, and alpha subunit hCG. Vaginal health can be tracked with serym amyloid-P componen, Nafarelin, and pH monitoring, in addition to other means previously discussed. Toxic shock can be detected with serum TS antibodies (e.g., using a biosensor associated with a tampon). PID and chronic pelvic pain may be related to CA-125 levels. The probability of egg implantation can be monitored through measurements of placental protein PP14, MMP, and IGFBP-3, while fertility and cycle monitoring can be tracked to some degree by measurements of circadian temperature, PP5, PP10, PP15, and hDP200.

Monitoring of MW antigen can be useful as an indicator of cervical dysplasia or bleeding.

Progesterone or hLH beta core fragments in urine can also be monitored for prediction of menopause.

### (6) Sexually-Transmitted Diseases (STDS)

STDs such as chlamydia or gonorrhea can be detected by analysis of components in urine with a DNA-based test using a benchtop system by Cepheid. STDs are another large category of diseases that could readily be monitored with biosensors in disposable absorbent articles, and tied to an integrated health care system.

### (7) Saliva-Based Tests

Biosensors for detecting analytes in saliva can be used. Examples include products of Salimetrics (State College, Pennsylvania), which provides a suite of salivary enzyme-immunoassay (EIA) kits for analytes such as cortisol (an indicator of stress), DHEA (dehydroepiandrosterone), testosterone, estradiol, progesterone, melatonin, cotinine, neopterin, and sIgA (secretory immunoglobulin A). The Male/Female Testosterone Profile test kit and the Post Menopausal Panel (for hormone detection) of are also a saliva-based system. Saliva-based fertility testing devices are also commercially available for predicting the time of ovulation, including the “Lady Fertility Tester” distributed by Med-Direct.com.

Related innovations have been developed by Dr. Douglas Granger at Pennsylvania State University, as described by D. A. Granger et al., “Salivary Testosterone Determination in Studies of Child Health and Development,” Hormones and Behavior, Vol. 35,1999, pp.18-27, which discloses techniques for measuring hormones in children's saliva. See also www.hhdev.psu.edu/news/hhdmag/fall% 201999/fluid.html, which provides an overview of Granger's work, describing applications such as cancer screening, HIV detection, hormone tracking (DHEA, progesterone, etc.), cortisol, and a variety of other analytes normally measured in the blood.

### (8) Test Strips

The lateral flow immunochromatographic tests produced by Chembio Diagnostic Systems, Inc. (see chembio.com/tech.html) are one example of biosensor systems within the scope of the present invention. These test materials are designed for qualitative detection of various analytes. Based on the differences in their operational procedures, these immunologic test devices fall into three general categories: (1) one-step, lateral flow devices that detect hCG, hLH, PSA, Hepatitis-B surface antigen, Troponin-I, etc.; (2) two-step lateral flow devices detect antibodies to H-pylori, Mycobacterium tuberculosis, Trypanosoma cruzi (Chagas), Borrelia burgdorferi (Lyme), etc. in whole blood, serum or plasma; (3) assays that require off-line extraction of antigen before their detection, including assays for Chlamydia, Strep-A, Rotavirus, etc. The extraction procedures are said to be simple, rapid and to require no additional equipment.

The Chembio test strips use colloidal gold conjugates. These colloidal gold conjugates are stored in dry mobile state in the devices. On coming into contact with biological samples, the colloidal gold conjugate quickly becomes re-suspended and binds to antigen or antibody in the sample and moves across the membrane through capillary migration. If the colloidal gold has captured the specific antigen or antibody then a second antibody or antigen, immobilized at the test zone, captures the colloidal gold-coupled immune complex. A pink/purple line appears in the test zone. The intensity of the line color may vary with the concentration of the antigen or antibody.

### (9) Implanted Biosensors

Biosensors that require surgical implantation of a component in the body can also be used. Examples include chemical sensors that continuously monitor an analyte such as a protein or blood component. Implantable biosensor components can also include biosensor chips with an internal power source for generating signal. An implanted component can also be free of electronic devices or power sources, but can yield a signal in response to applied radiation, such as optical or microwave radiation. One example includes the implantable silicon-based mirrors described in N. D. Rowell, “Light Could Help Doctors Draw Less Blood,” Photonics Spectra, September 2001, pp. 68-72. Such implantable mirrors have been developed by pSiMedica (Malvern, UK), intended to improve noninvasive optical measurements of tissue or blood for detection of glucose levels, oxygen levels, and cancer detection. The mirrors can be 5 mm×0.5 mm, for example, and include alternating layers of highly porous and less porous silicon. The different refractive index of the layers reflects beams of light at the interface with interference occurring that affects that wavelength of the reflected beam. The reflected wavelength can be controlled by the thicknesses of the alternating layers. The mirrors can reflect near-infrared light that is not scattered by the tissue. The pores in the silicon can be filled with chemicals that bind to specific markers. Cancer markers or other components can bind and accumulate in the pores, changing the reflectivity of the mirror. An infrared beam shone onto a mirror from outside the body can then be reflected from the mirror, and the measured reflectivity can indicate the presence of markers in the pores.

The mirrors can break down to harmless silicic acid in the body, and theoretically can be adjusted to break down over a period of hours to years. Further information is provided in L. T. Canham et al., “Derivatized Porous Silicon Mirrors: Implantable Optical Components with Slow Resorbability,” Physica Status Solidi, November 2000, pp. 521-25.

### b. Biosensors in Absorbent Articles

Methods for incorporating biosensors in absorbent articles such as diapers or sanitary napkins are disclosed in U.S. patent applications Ser. Nos. 09/299,399; 09/517,441; 09/517,481; 09/342,784; 09/342,289; and in U.S. Pat. Nos. 6,186,991 and 5,468,236, all of which have been previously incorporated by reference. Any of these can be adapted for use with the present invention.

Methods have been disclosed for providing wetness indicators or other sensors in products such as diapers. For example, U.S. Pat. No. 3,460,123 of Bass discloses a wetness detector that emits a radio signal when a diaper is wetted. Related disclosures include U.S. Pat. No. 4,106,001 of Mahoney; U.S. Pat. No. 4,796,014 of Chia; U.S. Pat. No. 5,959,535 of Remsburg, which includes sending a signal to an FM radio receiver when a diaper is wetted; U.S. Pat. No. 5,570,082 of Mahgerefteh et al.; and U.S. Pat. No. 5,838,240 of Johnson; each of which is incorporated herein by reference. Sensors for detecting odor in diapers due to defecation are disclosed by D. Yoshiteru et al., “Development of the Sensor System for Defecation,” Ishikawaken Kogyo Shikenjo Kenkyu Hokoku (Report of the Industrial Research Institute of Ishikawa, Japan), No.49, 2000, pp. 5-10 (based on abstract).

A further example includes a sanitary napkin or panty liner containing a visual, pH-indicating strip that can detect an infection. The user or a care giver can manually translate the color signal into an entry into a personal data control means to convey the biosensor signal electronically, or the article can include electronic means to generate a signal from the detection means, such as an electronic pH indicator and wireless transmission of the measurement.

Biocatalytic means such as enzymes can be included in absorbent articles to cause a reaction with a targeted analyte that in turn leads to a measurable signal. For example, enzymes in a hydrogel, superabsorbent particles, or an emollient in a diaper can react with an analyte such as glucose or urea to cause a color change or electric signal that can be measured. In one embodiment, an indicator gel is used including oxidoreductase enzymes that produce hydrogen peroxide upon reaction with an analyte in a body fluid. The hydrogen peroxide can then oxidize a colorless compound to create a colored agent, or can bleach a dye, to visually indicate the presence of the analyte.

### c. Electronic Systems

Numerous electronic systems have been developed to monitor sensor signals, store data, transmit signals to professionals, and the like, any of which can be employed in the present invention, particularly for transmitting information received from the UWB receiver to other information systems, such as sending a signal to a physician or other caregiver, or archiving data in a data warehouse or other source, providing orders to a pharmacy, and so forth.

Any suitable hardware and software can be used. Internet hubs, switches and routers, for example, or Microsoft Windows-based systems and UNIX-based can be used. Apache Web server software may be used. Server security can be provided with suitable hardware and software systems. For example, Internet firewall software by Celestix Networks can be used. Communication between servers can occur, for example, over a LAN (e.g., via an Ethernet or a Token Ring network), a wireless local area network (WLAN) using infrared (IR), ultrasonic, radiofrequency (RF), acoustic, or other wireless transmission means (including the telematic system proposed in EP 0 970 655 A1, published Jan. 12, 2000, disclosing the use of mobile phones for transmitting glucose information to a central location), a secure Intranet or via a secure Web-based system. Networks may be switched, optical, or use other technologies. Groupware systems can be employed, which use computer networking technology to allow multiple systems and individuals to communicate. The Lotus Notes/Domino system, for example, can be used to support communication between servers and Web-based applications for Intranets and other systems. Novell Groupwise is another example. The Groove system of Groove Networks, Inc. can also be used. This system includes synchronization technology that stores data for intended recipients that are offline and later forwards that data when the recipients eventually re-connect. Groove is an extensible platform and can be expanded or customized using the Groove Development Kit.

Customized applications for the present invention can be written in code from any appropriate programming language, such as C++, FORTRAN, Perl, and Python, or by using HTML web pages. Data elements can be exchanged using electronic data interchange or extensible markup language (XML). In one embodiment, a Web-based system can be used for one or more aspects of the present invention, including establishing user options and entering a privacy input to specify how personal health data can be shared with others, as disclosed in commonly owned U.S. patent application Ser. No. unknown, “Healthcare Networks with Biosensors,” filed the same day as the present application herein incorporated by reference. A Web-based system can also be used for providing a display of biosensor information for the user or outside parties, for administration of data allocation and processing, for retrieval of medical records, and the like. A Web-based system can incorporate one or more databases and can employ any server such as SQL or Oracle database servers. A Web-based system also can employ XQuery, an XML query language, as described by Charles Babcock, “The Ask Master: An XML Technology Makes Retrieving Web Data Much Easier,” Interactive Week, Sep. 24, 2001, p. 48, and further described at http://www.w3.org/TR/xquery. An XQuery system, for example, could query a relational database such as a medical records database and user authentication database, as well as electronic data provided via Web pages or e-mail, incorporating data from several sources into a single XML document or Web page. The Web-based environment may be secured by any suitable means.

Many tools such as encryption are known for providing secure transmission of data. Special precautions may be desired when wireless transmission of data is used. The IEEE Wired Equivalency Protocol (WEP) can be used. To increase security, WLAN access points can be placed outside the firewall of the network or the central server, and WLAN boxes can be required to use a Virtual Private Network (VPN) to access the network. WLANs can be provided through a variety of vendors such as Catalyst International, Select, Inc., Advanced Technology Solutions (ATS), and Luna Communications. Hardware components can include, for example, Proxim Harmony Wireless units. For facilities containing a plurality of subjects with biosensors, one exemplary embodiment entails use of a Proxim Harmony 801.11b wireless network infrastructure for the facility, which can be provided through ATS. Cisco Aironet bridges can also be used for higher levels of security, due to their 128-bit encryption and Direct Sequence Spread Spectrum (DSSS) technology (see Fred Aun, “Bank on Wireless,” Smart Partner, Sep. 10, 2001, pp.12-16). Examples of hardware for wireless access points include the modular Lucent OriNoco AS-2000 Access Point (permitting migration to future IEEE 802.11 high-speed technologies) or the AP-500 Wireless Access Point, which can be connected to a computer, for example, with an ORiNOCO PC Card.

Hardware and software systems specific to medical data and healthcare can play a role in the scope of the present invention. For example, Agilent has developed hardware and software for monitoring a patient and having results transmitted to a doctor, which can be adapted for home care or care in other settings. LifeChart.com also offers monitors for several illnesses (e.g., asthma) that involve electronic transmission of results to a doctor using secure software on the Internet. Medscape offers products that provide electronic charts that a doctor can readily update.

Parkstone Medical Information Systems offers a handheld device to permit doctors to enter notes, look up information on drugs, and place an order to the patient's pharmacy. Partners with drug companies to give preference to certain drugs, or with HMOs to offer generic drugs preferentially. Handheld devices used by doctors or patients can then be linked to a network and participate in the functions of the present invention (e.g., to receive raw data or interpreted data from the biosensor). The i-STAT® Portable Clinical Analyzer, for example, can be used in conjunction with i-STAT cartridges for the simultaneous quantitative determination of specific analytes in whole blood. Some handheld devices contain a medical dictionary and pharmaceutical tools, and may hold medical records and best-practice treatments, as described in Interactive Week, Mar. 19, 2001, pp. 26-29 (especially. p. 28).

While the invention has been described in conjunction with several specific embodiments, it is to be understood that many alternatives, modifications and variations will be apparent to those skilled in the art in light of the foregoing description. Accordingly, this invention is intended to embrace all such alternatives, modifications and variations that fall within the spirit and scope of the appended claims.

What is claimed is:

1. A wireless healthcare monitoring system, comprising:
at least one UWB biosensor transmitter, said biosensor transmitter associated with a biosensor disposed to detect a health condition of a user and generate a corresponding biosensor reading, said reading converted by said biosensor transmitter to a UWB biosensor signal transmitted by said transmitter;
a UWB receiver disposed remote from and within range of said transmitter, said receiver receiving and converting said UWB biosensor signal to a signal containing information from said biosensor reading; and
a processor in communication with said UWB receiver to process said 10 converted signal and provide a readable output indicating a health condition of the user detected by said biosensor.

2. The system as in claim 1, further comprising a plurality of said biosensor transmitters configured for simultaneously monitoring a plurality of users, each biosensor transmitter generating a respective biosensor signal.

3. The system as in claim 1, wherein said biosensor transmitter is configured to be carried on or against the body of the user and generates a biosensor reading from a biological sample from the user's body.

4. The system as in claim 1, wherein said biosensor transmitter is placeable in an article worn by the user.

5. The system as in claim 4, wherein said biosensor transmitter is placeable in an absorbent article worn by the user and detects an analyte in bodily waste absorbed by the absorbent article.

6. The system as in claim 5, wherein said absorbent article is one of a diaper, training pant, bed pad, sanitary napkin, panty liner, tampon, interlabial device, colostomy bag, breast pad, incontinence pad, brief, and undergarment.

7. The system as in claim 3, wherein said biosensor transmitter is placeable against the user's skin.

8. The system as in claim 1, wherein said biosensor transmitter detects an analyte in a medium from the user's body, the analyte indicative of a health condition of the user.

9. The system as in claim 8, wherein said biosensor transmitter is placeable in a device for collection of bodily wastes or fluids.

10. The system as in claim 1, wherein said biosensor transmitter is placeable remote from the user and detects a health condition from a biological sample expelled by the user.

11. The system as in claim 1, wherein said processor comprises a visual display means.

12. The system as in claim 1, wherein said processor comprises an alarm in the event of a detected abnormal biosensor reading.

13. The system as in claim 1, wherein the biosensor signal contains a code to identify the user.

14. The system as in claim 1, wherein the biosensor signal contains a code to identify the biosensor.

15. The system as in claim 1, wherein the biosensor signal contains a code to identify the location of the user.

16. The system as in claim 1, wherein the biosensor signal comprises data from a plurality of sensors.

17. A wireless healthcare monitoring system for simultaneously monitoring a plurality of users for a plurality of healthcare conditions, comprising:
a plurality of UWB biosensor transmitters, each of the monitored users being assigned at least one respective said biosensor transmitter;
each said biosensor transmitter comprising a biosensor element that detects an analyte in a biological sample from the respective user and generates a corresponding biosensor reading therefrom;
each said biosensor transmitter comprising a power supply, a self-powered UWB signal generator device that converts said biosensor reading to a UWB biosensor signal, and a transmitter with associated antenna to transmit said UWB biosensor signal;
a UWB receiver in communication with said biosensor transmitters for simultaneous receipt of said biosensor signals; and
a processor and display system configured to process and display information contained in said initial biosensor readings to a monitoring healthcare professional.

18. The system as in claim 17, wherein said biosensor transmitters are configured to detect an analyte in a biological sample from the users, the analyte being indicative of a particular health condition.

19. The system as in claim 18, wherein said biosensor transmitters are carried against the users' bodies.

20. The system as in claim 18, wherein said biosensor transmitters are placed in absorbent articles worn by the users.

21. The system as in claim 18, wherein said biosensor transmitters are placed in collection devices of bodily wastes from the users.

22. A method for wireless monitoring of individuals for health conditions, said method comprising:
assigning a biosensor transmitter to each individual to be monitored, the biosensor transmitter including a biosensor element that detects a health condition of the individual and a UWB transmitter operatively configured with the biosensor element;
detecting a health condition of the monitored individuals with the biosensor transmitter and transmitting a UWB biosensor signal from the biosensor transmitters to a UWB receiver;
receiving and converting the UWB biosensor signals to readable outputs indicating the health conditions monitored by the biosensor transmitters.

23. The method as in claim 22, wherein a plurality of individuals are monitored.

24. The method as in claim 23, wherein the plurality of individuals are in a common structure.

25. The method as in claim 23, wherein the plurality of individuals are infants in a nursery.

26. The method as in claim 22, further comprising transmitting the biosensor signal directly to emergency medical personnel in the event the biosensor signal indicates a health condition requiring immediate attention.

27. The method as in claim 22, wherein the health conditions are monitored by the biosensor transmitters by detection of analytes in a biological sample from the individuals.

28. The method as in claim 27, wherein the biological samples are withdraw or collected from the user's body prior to detection of the analyte by the biosensor element.

29. The method as in claim 28, wherein the medium is invasively withdrawn from the user.

30. The method as in claim 27, wherein the biosensor detects the analyte in the body of the user.

31. The method as in claim 27, wherein the biosensor is placed on or adjacent to the user's body.

32. The method as in claim 31, wherein the biosensor is implanted in the user's body.

33. The method as in claim 27, wherein the biosensor is placed in an article worn by the user.

34. The method as in claim 33, wherein the biosensor is placed in an absorbent article worn by the user.

35. The method as in claim 27, wherein the biosensor is placed in a collection device for bodily fluids or waste.

36. The method as in claim 22, comprising monitoring for a health condition with the biosensor transmitters on a generally continuous basis.

37. The method as in claim 22, comprising monitoring for a health condition with the biosensor transmitters on an intermittent basis.

38. The method as in claim 22, wherein the biosensor transmitters are a single use disposable item.

39. The method as in claim 22, wherein the biosensor signal provides a qualitative measurement.

40. The method as in claim 22, wherein the biosensor signal provides a quantitative measurement.

41. The method as in claim 22, wherein the biosensor signal is a time-averaged signal derived from a plurality of measurements taken over a period of time.
